(19) United States
(12) Patent Application Publication
(10) Pub. No.: US 2024/0303475 A1
(43) Pub. Date: Sep. 12, 2024

(54) SYSTEM, APPARATUS AND METHODS OF PRIVACY PROTECTION

(71) Applicant: HUAWEI TECHNOLOGIES CO., LTD., SHENZHEN (CN)

(72) Inventors: Chenchen YANG, Kanata (CA); Hang ZHANG, Kanata (CA); Xu LI, Kanata (CA); Bidi YING, Kanata (CA)

(73) Assignee: HUAWEI TECHNOLOGIES CO., LTD., SHENZHEN (CN)

(21) Appl. No.: 18/667,699

(22) Filed: May 17, 2024

Related U.S. Application Data
(63) Continuation of application No. PCT/CN2021/131746, filed on Nov. 19, 2021.

(51) Int. Cl. G06N 3/0475; G06N 3/0985

(52) U.S. Cl. CPC G06N 3/0475; G06N 3/0985

(57) ABSTRACT

A method of privacy protection includes receiving from a service customer, a service request requesting for a service of privacy protection. A generative model is used to generate synthetic data based on the service request and the synthetic data is provided to a discriminator. The discriminator performs a comparison between data from the service customer and the received synthetic data, and providing a result of the comparison to the generator, where privacy of the service customer is included in or inferred from the data from the service customer. Based on the result of the comparison from the discriminator, the generator updates the generative model until the generated synthetic data meets a preconfigured requirement. Each time the generative model is updated, newly updated synthetic data is provide to the discriminator. Once the preconfigured requirement is met, the latest synthetic data or the latest generative model is provided to a data consumer.

### CROSS-REFERENCE TO RELATED APPLICATIONS

This application is a continuation of International Patent Application No. PCT/CN2021/131746 filed Nov. 19, 2021 entitled “SYSTEM, APPARATUS AND METHODS OF PRIVACY PROTECTION”.

### TECHNICAL FIELD

The present invention pertains to the field of machine learning (ML) techniques, and in particular to a method, apparatus and system of privacy protection.

### BACKGROUND

Machine learning (ML) techniques have the ability to synthesize data that is statistically similar to the original real or realistic data and that may be used in place of the original data for many computing applications. Generative neural networks (GNNs) are one of the techniques being investigated and include classes of neural networks such as generative adversarial network (GAN) and variational autoencoder (VAE). GAN frameworks involve two machine learning models, a generator and a discriminator. A generator receives randomly distributed data, such as Gaussian noise, and attempts to generate synthetic data with a similar distribution and similar characteristics to reference data. Synthetic data may include image, text, video, audio, location, trajectory, network measurement result and sensing data. Discriminators receive both the synthetic data and real data and attempt to discern the synthetic data from the real data. VAE or auto-encoder frameworks involve two main parts i.e. an encoder and a decoder. The encoder maps the input data into code, and the decoder maps the code to a reconstruction of the input data. A VAE or auto-encoder may be a neural network including an input layer, one or more hidden layers and an output layer. The encoder may include a input layer and one or more hidden layers, and the decoder may include a output layer and one or more hidden layers. The decoder reconstructs the input data of input layers e.g. via minimizing the difference between the input data of the input layer and the output data of the output layer.

Both generators and discriminators can be implemented by deep learning networks, neural networks, classifiers etc. A generator and discriminator are trained together where the generator attempts to generate synthetic data to fool the discriminator, while the discriminator attempts to differentiate between the real data and synthetic data. Once a generator is sufficiently trained, the GAN can reach an equilibrium state and the discriminator will be unable to distinguish between the synthetic data and the real data. At that point, it is possible to use the synthetic data in place of real data for the purpose of training other ML models and other applications.

In some applications, assistant or labeled data may be used to help the discriminator to not only distinguish whether each sample is real, but also to complete a classification task. This may be implemented by adding an auxiliary classifier in the discriminator network. In these applications, in addition to the real data, labeled data is also provided to the discriminator to aid in the classification of data. GAN includes frameworks such as conditional GAN (CGAN), auxiliary classifier GAN (ACGAN), semi-supervised GAN, and information GAN (infoGAN). Assistant data may be used to train the generative model.

In present day applications, the provider of the real, realistic data used for training may have a number of privacy concerns that require them to control what other parties have access to their private data. However, the operator of the GAN requires access to the private data at least to train the discriminator ML engine or model. Some GAN operators may also require the use of a third party, AI-enabled entity to provide execution resources used for training the generator and discriminator ML engines. There exists a need for methods and apparatus that are able to train the GAN while preserving the privacy of the realistic data.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide a method, apparatus and system for privacy protection, which is also called data privacy protection. Embodiments include generation of synthetic data and determination of a generative model which generates the synthetic data where privacy of source data is protected, namely preserved, and access to private data by un-trusted parties may be prevented. In some embodiments, model(s) is further updated, e.g., through training based on one or more rounds of communication and feedback, so that the synthetic data is also updated until ready for transmission to a data consumer.

Embodiments provide for the training of generative models and the generation of synthetic data which may be used in a variety of applications. One or both of generative model(s) and synthetic data may be distributed to a data consumer allowing the data consumer to operate their systems or to work on private data without having access to the realistic private data itself, e.g., the privacy of the service customer. Flexibility in the delivery of generative models and/or synthetic data allows for information to be delivered to the data consumer while attempting to optimize available network bandwidth. In following embodiments, the expressions “realistic private data”, “real data”, “realistic data” and “private data” are used exchangeable when referring to data from a service customer, where the privacy of the service customer is included in or can be inferred from the data.

In accordance with embodiments of the present invention, there is provided a method of privacy protection including receiving, by a generator from a service customer, a service request requesting for a service of data privacy protection. Then determining, by the generator, a generative model to generate synthetic data based on the service request. Furthermore, performing, by the generative model, a generation of synthetic data, and providing the synthetic data to a discriminator, performing, by a discriminative model invoked by the discriminator, a comparison between data from the service customer and received synthetic data, and providing a result of the comparison to the generator, wherein privacy of the service customer is included in or inferred from the data from the service customer. According to the result of the comparison from the discriminator, updating, by the generator, the generative model until updated synthetic data generated by updated generative model meets a preconfigured requirement. Each time when the generative model is updated, providing newly updated synthetic data to the discriminator. Once the preconfigured requirement is met, providing, by the generator to a data consumer, at least one of: the latest updated synthetic data which meets the preconfigured requirement, and configuration information enabling an establishment of the latest updated generative model which generated the latest updated synthetic data, wherein the data consumer has no authorization to access the privacy of the service customer.

This may provide the technical benefit of allowing synthetic data to be used in place of (source) data where privacy of a data provider is included or inferred from, thereby preserving the privacy of the data provider.

In further embodiments, the service request from the service customer includes a requirement of a generative model and the generative model determined by the generator meets the requirement of the generative model, wherein the requirement of the generative model includes one or more of a model ID identifying the generative model, a model size of the generative model, an accuracy level to be supported by the generative model, a privacy level to be supported by the generative model, a computing or time resource requirement to establish the generative model. Validity information indicates one or more of a valid data type to be supported by the generative model, and when or where one of the generative model and data as input to the generative model is valid, a data compression ratio to be supported by the generative model, a model type to be supported by the generative model, hyper-parameters associated with the generative model, and weights between neurons of a neural network associated with the generative model.

This may help the generator to efficiently establish and determine a generative model which can better protect the privacy of the data provider and better satisfy the service customer's request e.g., providing flexibility in limiting the time spent generating the generative model.

In further embodiments, the model type includes one of a model based on a generative adversarial network (GAN), a model based on a generative neural network (GNN), a model based on an auto-encoder, and a model based on a variational auto-encoder (VAE).

In further embodiments, the generator has no authorization to access the privacy from the service customer. The method further includes performing, by the generative model, a generation of synthetic data including generating, by the generative model, synthetic data according to random data and the service request.

In further embodiments, the updating the generative model includes updating at least one weight between neurons of a neural network associated with the generative model or at least one hyper-parameter associated with the generative model.

In further embodiments, the generator is located in a first entity which has no interface supporting a transmission of the service request from the service customer, the discriminator is located in a second entity which has an interface supporting a transmission of the service request from the service customer, wherein the generator receives the service request from the service customer via the discriminator. It will be readily understood that the expression that “one entity is located in another entity” can be to be that the former entity is deployed in the hardware, software or virtual functions of the latter entity, and can be invoked by the latter entity.

Further embodiments include receiving, by the discriminator from the service customer, a set of parameters to determine the discriminative model, and determining, by the discriminator, the discriminative model according to the set of parameters.

In further embodiments, the second entity is a data de-privatization (DP) service provider, and the method further includes receiving, by the generator from the data DP service provider, a split indication indicating that a generative model is required to output data for a comparison performed by a discriminative model, where the generator determines the generative model according to the split indication.

In further embodiments, the generator is located in a first entity which has an interface supporting a transmission of the service request from the service customer, the discriminator is located in the service customer. The service request includes a split indication indicating that a generative model is required to output data for a comparison performed by a discriminative model.

Further embodiments include determining, by the service customer, the discriminative model according to a local stored set of parameters.

In further embodiments, the generator and the discriminator are located in an entity, wherein the service request is received by the entity from the service customer.

In further embodiments, the entity is a data de-privatization (DP) service provider whose interface with the service customer supports a transmission of one or more of the service request and the data, or the entity has an interface with a DP service provider and no interface with the service customer, while the DP service provider has an interface supporting a transmission of one or more of the service request and the data with the service customer, and the service request is received by the entity from the service customer via the DP service provider.

In further embodiments, the DP service provider is configured to determine how to generate the generative model and the discriminator model according to the service request.

Further embodiments include one of receiving, by the discriminator, the data from the service customer via an interface between the discriminator and the service customer, and obtaining, by the discriminator, the data locally in the service customer wherein the discriminator is located in the service customer.

Further embodiments include for each time when the synthetic data is generated, determining, by the generator, where the preconfigured requirement is met. The preconfigured requirement indicates at least one of how many times the synthetic data can be generated at most, how many times the generative model can be updated at most, how much similarity is between latest two generative models at least, and an indication is received from the discriminator wherein the indication indicates to provide the latest updated synthetic data or the configuration information enabling the establishment of the latest updated generative model to the data consumer. The number of times can be indicated with a specific numerical value.

This may provide the technical benefit of providing flexibility in limiting the time spent generating the generative model.

Further embodiments include sending, by the discriminator to the generator, a message including the preconfigured requirement to configure the preconfigured requirement into the generator, wherein the discriminator and the generator are located in different entities.

In further embodiments, the discriminator is located in the service customer and the message including the preconfigured requirement is the service request from the service customer.

Further embodiments include, for each time when the comparison is performed, determining, by the discriminator, whether the preconfigured requirement is met, where the preconfigured requirement indicating at least one of how many comparisons can be performed at most, and how many times the discriminative model can be updated at most.

In further embodiments, the preconfigured requirement is preconfigured into the discriminator by the service customer.

In further embodiments, the preconfigured requirement is preconfigured locally when the discriminator is located in the service customer, or the preconfigured requirement is preconfigured via a message sent on an interface between the service customer and the discriminator.

Further embodiments include sending, by the discriminator to the generator, a message indicating that the preconfigured requirement is met when the times the comparison is performed by the discriminator reaches that indicated in the preconfigured requirement or when update times of the discriminative model reaches that indicated in the preconfigured requirement.

In further embodiments, the comparison includes a comparison between a result of data analysis on the data from the service customer and a result of data analysis on the received synthetic data.

In further embodiments, the service request from the service customer includes a data consumer identifier that identifies the data consumer, and the generator provides to a data consumer at least one of the latest updated synthetic data and configuration information via an interface between the generator and the data consumer.

In further embodiments, the generator does not know which data consumer to provide the at least one of the latest updated synthetic data and configuration information, the generator provides the at least one of the latest updated synthetic data and configuration information to the service customer so that the service customer determines the data consumer and provides the at least one of the latest updated synthetic data and configuration information to the data consumer.

Further embodiments include receiving, by the data consumer, the configuration information, and generating, by the data consumer, synthetic data by invoking a generative model which is established according to the configuration information. It may protect the privacy included in the original data, at the same time can reduce the data delivery overhead by delivering the model configuration information instead of the original data or synthetic data.

In further embodiments, the privacy of the service customer cannot be included or inferred from the latest updated synthetic data which meets the preconfigured requirement.

In further embodiments, the configuration information for the establishment of the latest updated generative model includes one or more descriptions of a generative model including a model ID identifying the generative model, a model size of the generative model, an accuracy level supported by the generative model, a privacy level supported by the generative model, a computing or time resource requirement to establish the generative model, validity information indicating one or more of valid data type supported by the generative model, and when or where one of the generative model and data as input to the generative model is valid, and a data compression ratio supported by the generative model.

This may help the data consumer to use the generative model in the right and suitable conditions and scenarios, and to flexibly and efficiently establish the generative model.

In further embodiments, the validity information includes one or more of time information indicating at which time one of the generative model and data as input to the generative model is valid, a time period indicating during which time period one of the generative model and data as input to the generative model is valid, location information indicating within which area one of the generative model and data as input to the generative model is valid, and a requirement on one of a valid data source and a valid operation platform.

In further embodiments, the area indicated by the location information includes one of a public land mobile network (PLMN), a non-public network (NPN), an area related to a network slice, a tracking area (TA) of a terminal, and a network cell.

In further embodiments, the requirement includes one of parameters of following data source of the generative model or operation platform of the generative model including a user equipment (UE), a data source type, a radio access network (RAN) node, and a network function (NF).

In further embodiments, the configuration information for the establishment of the latest updated generative model further includes weights between neurons of a neural network associated with the latest updated generative model, and hyper-parameters associated with the latest updated generative model.

In further embodiments, the data consumer is a data collection entity, and the method further includes establishing, by the data collection entity, a generative model according to the configuration information, wherein the generative model is identified by a model ID.

In further embodiments, the generative model is one of established generative models in the data collection entity, and the method further includes receiving, by the data collection entity from a requester, a request requesting for a service of a collection of data, sending, by the data collection entity to one or more data source entities, a request including one or more model IDs each corresponding to one generative model of the established generative models, and a requirement on the collection of data, receiving, by the data collection entity from at least one of the one or more data source entities, a first model ID identifying a first generative model, wherein synthetic data generated by the first generative model meets the requirement, and sending, by the data collection entity to the requester, at least one of the first model ID, configuration information enabling an establishment of the first generative model, and synthetic data, which is generated by the first generative model invoked by the data collection entity locally.

This may reduce the data delivery overhead e.g. the communication cost for data collection entity and data source during the data collection produce, increasing the data collection efficiency, at the same time the privacy can be protected.

In further embodiments, the request sent by the data collection entity to one or more data resource entities is one of a radio resource control (RRC) message, system information (SI), user plane (UP) signalling, a message within a core network, a message between a core network and a radio access network (RAN), an inter-RAN node message, an intra-RAN node message, and a paging message.

In accordance with embodiments of the present invention, there is provided a system including a generator and a discriminator, wherein the system is configured to perform a method described herein.

In accordance with embodiments of the present invention, there is provided an apparatus comprising a processor and a memory storing instructions which when executed by the processor configure the apparatus to execute steps of receiving, from a service customer, a service request requesting for a service of data privacy protection. Then, determining a generative model to generate synthetic data based on the service request. Also, performing, by the generative model, a generation of synthetic data, and providing the synthetic data to a discriminator. Also, receiving, from the discriminator, a result of a comparison between data from the service customer and received synthetic data, where the privacy of the service customer is included or inferred from the data from the service customer. According to the result of the comparison from the discriminator, updating the generative model until updated synthetic data generated by updated generative model meets a preconfigured requirement, and each time when the generative model is updated, providing newly updated synthetic data to the discriminator. Once the preconfigured requirement is met, providing, to a data consumer, at least one of the latest updated synthetic data which meets the preconfigured requirement, and configuration information enabling an establishment of the latest updated generative model which generated the latest updated synthetic data, wherein the data consumer has no authorization to access the privacy of the service customer.

In accordance with embodiments of the present invention, there is provided a computer readable medium storing instructions which when executed by a processor configure an apparatus to execute steps of receiving, from a service customer, a service request requesting for a service of privacy protection. Also, determining a generative model to generate synthetic data based on the service request. Also, performing, by the generative model, a generation of synthetic data, and providing the synthetic data to a discriminator. As well, receiving, from the discriminator, a result of a comparison between data from the service customer and received synthetic data, wherein the privacy of the service customer is included in or inferred from the data from the service customer. According to the result of the comparison from the discriminator, updating the generative model until updated synthetic data generated by updated generative model meets a preconfigured requirement, and each time when the generative model is updated, providing newly updated synthetic data to the discriminator. Once the preconfigured requirement is met, providing, to a data consumer, at least one of the latest updated synthetic data which meets the preconfigured requirement, and configuration information enabling an establishment of the latest updated generative model which generated the latest updated synthetic data, wherein the data consumer has no authorization to access the privacy of the service customer.

Embodiments may provide numerous technical benefits in the location of the generator and discriminator in a system. Further technical benefits may be that embodiments allow a high degree of flexibility in which entity controls each part of the methods described herein and which entities have access to private data as described herein. Other technical benefits may include highly customizable requests for services that allows for embodiments to be used in a wide variety of applications.

Embodiments have been described above in conjunctions with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present invention will become apparent from the following detailed description, taken in combination with the appended drawings, in which:

FIG. 1 illustrates a general framework for a generative adversarial network (GAN), according to an embodiment.

FIG. 2 illustrates the components of a DAM consortium, according to an embodiment.

FIG. 3 illustrates a method for transmitting collected data to a data consumer within a DAM, according to an embodiment.

FIG. 4 illustrates a method for a DAM to publish a synthetic dataset instead of an original private dataset, according to an embodiment.

FIG. 5 illustrates a classification of methods that may be used to de-privatize data, according to an embodiment.

FIG. 6 illustrates an architecture for data de-privatization including a data synthetization function, according to an embodiment.

FIG. 7 illustrates a method for a DAM to execute all data synthetization function (DSF) tasks, according to an embodiment.

FIG. 8 illustrates a method for a DP service customer to provide private data to a DAM-DP, and a DAM-DP to output synthetic data or a generative model to a data consumer, according to an embodiment.

FIG. 9 illustrates method for an AI-enabled party to help a DAM execute required DSF tasks, according to an embodiment.

FIG. 10 illustrates a method for a DP service customer to provide data to a DAM-DP, the DP to request help of AI-enabled party, and the AI-enabled party to output synthetic data or a generative model to the DAM-DP, or to a data consumer, according to an embodiment.

FIG. 11 illustrates a method where a DAM executes required DSF tasks, or an AI-enabled party helps the DAM to execute the required DSF tasks, according to an embodiment.

FIG. 12 illustrates function splitting among a DP service customer, a DP service provider, and an AI-enabled party, according to an embodiment.

FIG. 13 illustrates a method for a DP service customer to supply private data to a DP service provider and the DP service provider to execute the discriminator components while an AI-enabled party executes the generator component, according to an embodiment.

FIG. 14 illustrates an architecture for data de-privatization with a data synthetization function, according to an embodiment.

FIG. 15 illustrates a method where a DP service provider cooperates with an AI-enabled party to execute DSF tasks, according to an embodiment.

FIG. 16 illustrates function splitting among a DP service customer and DP service provider, according to an embodiment.

FIG. 17 illustrates an architecture where a DP service customer executes discriminator components and a DP service provider executes the generator components of DSF tasks, according to an embodiment.

FIG. 18 illustrates a method where a DP service provider cooperates with a DP service customer to execute the DSF tasks, according to an embodiment.

FIG. 19 illustrates an architecture for data collection with DSF, according to an embodiment.

FIG. 20A and FIG. 20B illustrate a method for data collection with a DSF, according to an embodiment.

FIG. 21 illustrates the relationships between a discriminator and generator, and a service customer, data consumer, or other entity, according to an embodiment.

FIG. 22 illustrates a workflow to determine a generative model, according to an embodiment.

FIG. 23 illustrates the relationships between a discriminator and generator, and a service customer, data consumer, or other entity, with respect to FIG. 7 and FIG. 8, according to an embodiment.

FIG. 24 illustrates the relationships between a discriminator and generator, and a service customer, data consumer, or other entity, with respect to FIG. 9 and FIG. 10, according to an embodiment.

FIG. 25 illustrates the relationships between a discriminator and generator, and a service customer, data consumer, or other entity, with respect to FIG. 12 and FIG. 13, according to an embodiment.

FIG. 26 illustrates the relationships between a discriminator and generator, and a service customer, data consumer, or other entity, with respect to FIG. 16 and FIG. 17, according to an embodiment.

FIG. 27 illustrates a neural network that may be used in embodiment, according to an embodiment.

FIG. 28 illustrates an electronic device that may perform any or all of operations of the methods and features described herein, according to an embodiment.

It will be noted that throughout the appended drawings, like features are identified by like reference numerals.

### DETAILED DESCRIPTION

Embodiments of the present disclosure relate to methods of data privacy protection via generating synthetic data based on private data. Embodiments include the determination of a generative model used to generate synthetic data so that the privacy of data is protected and access to private data by un-trusted parties may be prevented.

Embodiments provide for the determining of generative models by a generator and the generation of synthetic data which may be used in a variety of applications. The determining step may be also named as or may include a calculating step, an obtaining step, or selecting step. Generative models, synthetic data, or both generative models and synthetic data may be distributed to data consumers allowing the data consumers to operate their systems to work with private data without having access to the private data itself. Flexibility in the delivery of generative models and synthetic data allows for information to be delivered to data consumers while optimizing available network bandwidth.

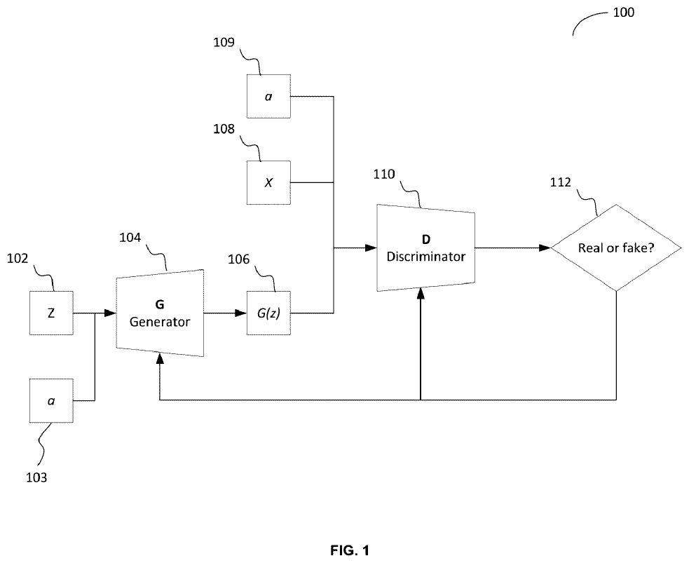

FIG. 1 illustrates a general framework for a generative adversarial network (GAN) 100, according to an embodiment. The GAN 100 is composed of two main portions, generator, G, 104 and discriminator, D, 110. Generator 104 is used for the creation of synthetic data such as image, text, video, audio, location, trajectory, network measurement results, sensing data, and others. The synthetic data is produced so that the discriminator 110 is unable to distinguish if it is synthetic data 106 or real realistic data 108. Generator 104 receives as an input, samples from random distribution, Z, 102 which may be Gaussian noise or samples with a uniform distribution. The generator 104 outputs synthetic data, G(z), 106 which may be used as useful data e.g., training data, inference data, for other systems e.g., data consumer once generator 104 has been trained. The output of generator 104 may also be configured as a ML model to be used as required to generate an arbitrary amount of synthetic data at any time.

Discriminator 110 evaluates samples of synthetic data 106 received from the generator 104 and attempts to discern if the synthetic data 106 belongs to a dataset of realistic data 108, or if it is synthetic data from generator 104. Discriminator 110 receives as an input, synthetic data 106 from generator 104 and data from realistic data 108 from a realistic training dataset. Discriminator 100 outputs a decision 112 on whether the input data is real or synthetic “fake” data. The decision output is used for training both the generative model 104 and discriminator model 110.

The workflow of a GAN may be described as follows. Random samples, z, 102 are input to generator 104 which creates synthetic data samples 106, where input z 102 has a random distribution such as Gaussian noise or a uniform distribution, Pz(z). The generator 104 outputs synthetic samples, G(z) 106. A synthetic sample 106 is input to the discriminator 110 together with a sample of real data, X, 108 from a realistic training dataset. The real data 108 of training dataset has a distribution Pr(x). The discriminator 110 estimates the probability that a sample is coming from the training dataset rather than the generator 104. The discriminator 110 returns a prediction as to whether a sample is synthetic (fake) or real, with a probability. In embodiments, the probability may be expressed as a number between 0 and 1 with 0 being definitely synthetic and 1 being definitely real. D(x) or D(G(z)) indicates the probability or prediction 112 that the discriminator 110 determines that the current input sample is a real sample. For example, the discriminator is trained to maximize a function of D(x) and D(G(z)).

The prediction 112 is used to train the generator 104 so that the discriminator 110 is unable to distinguish between the synthetic data 106 and the real data 108. The training procedure for generator 104 is to attempt to maximize the probability of discriminator 110 making a mistake (e.g., determining that synthetic data 106 is actually real data 108). The discriminator 110 in turn is trained to distinguish between synthetic data 106 from the generator 104 and real data 108. For example, the generator is trained to minimize the probability log(1−D(G(z))).

The purpose of the generator 104 is to learn the true distribution of the real data 108 of the training dataset, and to make G(z) 106 and real data 108 have similar distributions in the feature space. When the network is initially trained, the distributions of the synthetic data and the real data are quite different. At the beginning of training, the generator network is weak, and the discriminator network can easily distinguish the real data and the synthetic data. With the continuous iteration of training, the generator network and the discriminator network are constantly updated, the generated data is gradually closer to the real data, and finally an equilibrium is reached, and the discriminator 110 cannot distinguish the synthetic data 106 and the real data 108. When the training ends, a generative model trained in generator 104 captures the data distribution of the real data 108 of the training data set. The generative model can be regarded as the exact mapping of random variable z 102 to the real data 108 of the training dataset. Thus, after the training process, it is possible to use the generator 104 to generate a synthetic data 106 that shares the same properties as the real data 108. Assistant data 103 may be used by generator 104. Assistant data 109 may be used by discriminator 110. Assistant data may be class labels, conditional parameter, denial constraints, latent parameter, or auxiliary parameter. To protect the privacy of the original realistic data, the assistant data may be used to remove, filter, hide, or replace the sensitive and private information of the original realistic data of the service customer or the data source.

In embodiments, discriminator 110 may also have to complete a classification task on either synthetic data 106 or real data 108. In these applications, assistant data 103 and 109, which may be class labels, conditional data or denial constraints, can be used. Assistant data 103 may be used together with random data 102, while assistant data 109 may be used together with real dataset 108. This may be implemented by adding an auxiliary classifier in the discriminator 110. Labeled data is fed into discriminator 110 to assist the discriminator 110 in making a discrimination. During training, the discriminator performs both an unsupervised part (e.g. determining if data is real data or synthetic data) and a supervised part (e.g. labeling data). The discriminator is to classify labeled real data and unlabeled real data in the correct classes, and the generated data in the synthetic class. If the data synthetic model (e.g., G model) is not trained, new coming data triggers the training, and the synthetic data or generative model is exposed to the data consumer. If the data synthetic model (e.g., G model) has already been trained or pre-configured, synthetic data is generated directly with the trained model for new coming data. It is noted that the generator and discriminator are not limited to be deployed as GAN, e.g. they may also be deployed as an auto-encoder or a VAE. We may also define the encoder as an auto-encoder or the VAE as a generator, and the term decoder as an auto-encoder or VAE as a discriminator. We may also define the output data of the decoder as synthetic data. When the auto-encoder or VAE is trained, the trained code and decoder model can be output to data consumer, or the synthetic data generated by decoder is output to the data consumer directly. The data consumer 810 can use the trained code and decoder model to create an almost unlimited amount of synthetic data 106 and perform data analytics or analysis on the synthetic data.

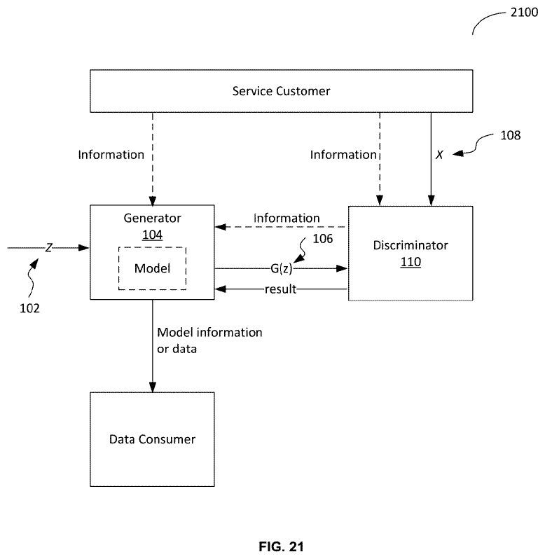

FIG. 21 illustrates the relationships between a discriminator and generator, and a service customer, data consumer, or other entity, according to an embodiment. A service customer interacts with either generator 104 or discriminator 110, or both the generator 104 and discriminator 110 to provide real dataset 108 and other information in order to utilize the system and methods described herein. A data consumer may obtain synthetic data 106 or model information allowing them to generate synthetic data on their own which protects the privacy of the service customer or other provider of the real dataset 108.

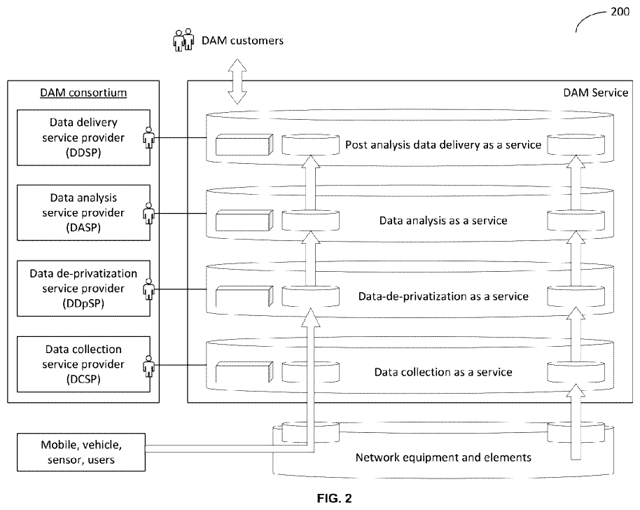

FIG. 2 illustrates the components of a data analytics and management (DAM) consortium 200, according to an embodiment. Embodiments may provide different services such as data collection (DC) services, data de-privatization (DP) services, data analysis (DA) services, and data delivery (DD) services. These services can be provided by one or multiple service providers organized in the DAM. The service provider can be an operator, vendor, network functions, network equipment, or a 3rd party. Each of these services may include one or more functions including control plan function, use plane function, data plane function and data processing plane function. Different service providers can form a consortium to provide one or more services. Other than the DAM consortium, there may be other platforms that provide services such as connection and intelligent computing services, data storage services, AI market services, data market services, etc. There may be interactions between these players to provide service cooperatively.

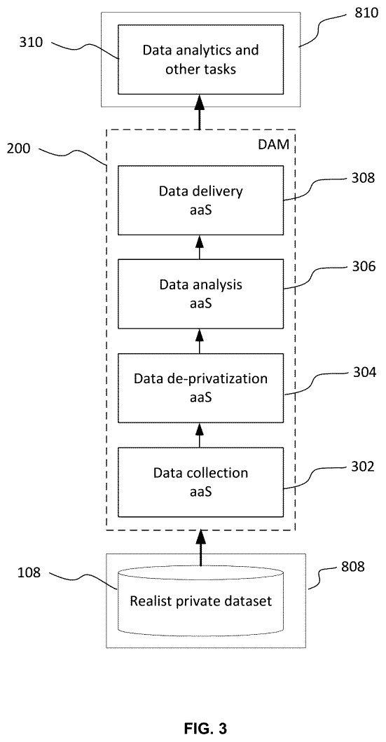

FIG. 3 illustrates how collected data may be transmitted to a data consumer 810 within a DAM 200, according to an embodiment. DAM 200 collects data from data source 808 such as a realistic private dataset 108 and then exposes the collected data to a data consumer 810. Data consumer 810 can use the data 108 to perform tasks 310 such as data analytics, AI training and AI inference. Data consumer 810 may be one of several service providers e.g., connection and intelligent computing service provider, data storage service provider, AI market service provider, data market service provider or another 3rd party player. The data collected from data source 808 may be private data for which the privacy should be protected. DAM 200 can include a DP service provider 806 to provide services such as data collection as a service 302, data de-privatization as a service 304, data analysis as a service 306, and data deliver as a service 308 in ways that protect data privacy before exposing synthetic data 106 or real data 108 to data consumer 810. The data consumer needs to use the private data from a service customer or a data source to perform a mission e.g., data analysis, AI training, or AI inference. The data consumer has no authorization to access the service customer's privacy which is included in or can be inferred from the original private data from the service customer. The data from service customer may also include the privacy of a data source because the data is collected from the data source by the service customer. We may also define the data source's privacy as the service customer's privacy. The privacy which is included in or can be inferred from the original private data may also be called data privacy. Privacy protection is also named as data privacy protection. The privacy of the service customer or the data source includes one or more of: identifier, location, trajectory, activity, biometric and other information that the service customer does not want to be exposed to the data consumer. The original private data is processed and excluded the privacy of the service customer or data source firstly, and then the processed data is exposed to the data consumer. For example, the privacy of the service customer or the data source cannot be inferred by the data consumer via analyzing the processed data. In the processed data, the sensitive and private data information of the original data from the service customer or the data source has been removed, filtered, hidden, or replaced. At the same time, the data consumer still can perform the mission with the processed data. The performance of the processed data is same as or close to that of the original private data when the processed data is used in place of the original private data by the data consumer to perform the mission. The responsibility of the DP service provider is to provide privacy protection service to the service customer or the data source. The DP service provider processes the original private data and excludes the privacy of the service customer or the data source from the original private data, and then delivers the processed data to the data consumer or back to the service customer. The processed data can be synthetic data generated based on the original private data or generative model which can be used to generate the synthetic data. De-privatization can be also named as privacy protection, and privacy-preserving. The synthetic data output to the data consumer can be also called de-privatized data.

Embodiments include a data synthetization function (DSF) 402 that may be configured into any DAM service provider such as a DAM DP service provider or DAM DC service provider. The main responsibility of a DSF 402 includes the generation of synthetic data 106 with a distribution and performance the same or as close to that of realistic data 108 for data consumer tasks such as data analytics. The DSF 402 also produces a data model (such as a generative model determined by generator 104) that can be used to generate the synthetic data 106. The DSF 402 may be capable of compressing the data information into a data model (e.g., generative model, discriminative model, encoder model, decoder model, information compression model, semantic information model on a network), based on the data model the synthetic data 106 can be generated or the realistic data 108 can be reconstructed. The DSF 402 may further generate a data model, based on the data model automatic data processing (e.g., data feature engineering, data labeling, data classification) could be performed. The DSF 402 can be supported by techniques such as generative neural networks and adversarial networks e.g., GAN, VAE. Necessary properties of original real data may be retained when DSF generates synthetic data e.g., to meet the requirement of data consumer. The data properties may be the data structure and correlations present in the original real dataset e.g., the underlying correlations and dependencies among tuples and attributes of the dataset.

In embodiments, in addition to being deployed in DAM service providers, the DSF 402 may also be deployed in a network on a user equipment (UE) side, a network side, such as in a radio access node (RAN), core network (CN), or as part of a network function (NF), or with a 3rd party.

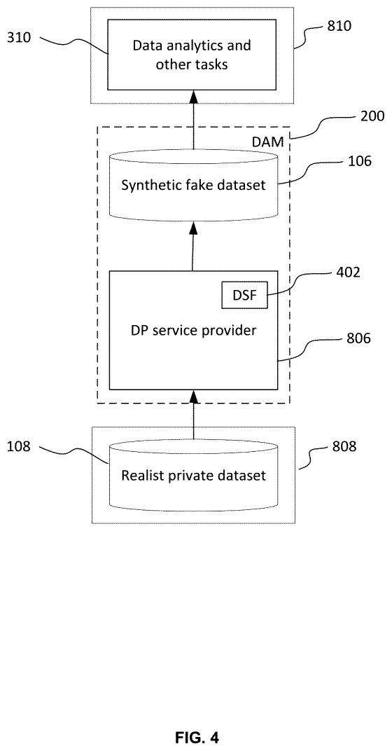

FIG. 4 illustrates how a DAM 200 may publish a synthetic dataset instead of an original private dataset, according to an embodiment. A DSF 402 can be deployed in a GAN 100 of a DP service provider 806 in order to synthesize a dataset 106 that is statistically similar to the original collected dataset 108. The use of statistically similar synthetic data in place of real, private data may be used for data de-privatization, that is to replace the use of private data with non-proprietary, synthetic data while still allowing data consumers to achieve comparable results in their applications. The DAM 200 instead of directly releasing the collected original realistic dataset 108 to a data consumer 810, may train a generative model using the original realistic data 108. Then the DAM (in this case, a DP service provider 806) publishes the synthetic dataset 106 generated by the generative model, or the DAM publishes the generative model from which arbitrary amounts of synthetic data 106 can be produced for analytics tasks. Data privacy can be preserved as the data analytics tasks in the data consumer 810 are conducted based on synthetic data 106 instead of the original real data 108. Data privacy can be preserved as it is more difficult to associate synthetic data with an individual than with original real data, thereby ensuring the privacy of individual data records. The original realistic data 108 is not exposed to the data consumer 810. Meanwhile, the utility of the synthetic dataset 106 can be guaranteed due to the statistical similarity of the synthetic data 106 and realistic data 108 in the feature space. When the original realistic dataset is collected and to be delivered to data consumer, if the generative model has not been trained or pre-configured, the original realistic dataset may trigger the training or configuration of the generative model. Then the generative model is exposed to data consumer, or the synthetic data is generated with the generative model and exposed to data consumer. When the original realistic dataset is collected and to be delivered to data consumer, if the generative model has already been trained or pre-configured, then the generative model is exposed to data consumer directly or the synthetic data is generated with the generative model directly with the generative model and exposed to data consumer.

In embodiments, the DSF can be deployed in a data collection (DC) service provider or in a data deliver (DD) service provider. In the DC procedure and the DD procedure, transmitting the data model (e.g., generative model) instead of the raw synthetic data 106 can reduce the required transmission bandwidth between the data source 808, the DAM 200 (the DC service provider 1902 or the DP service provider 806), and the data consumer 810, thereby increasing the data transmission efficiency of the system.

In embodiments, the DSF 402 can be deployed in DC service provider 1902 or a data analysis (DA) service provider. After collecting the raw data, data pre-processing, such as data labeling, data cleaning, data set division, missing value filling, feature correlation evaluation and data feature engineering, may be executed automatically by the DC service provider or the DA service provider via techniques implemented in the GAN 100.

In embodiments, examples of realistic private data 108 could be, but is not limited to location data (e.g., UE location, V2X location), trajectory data (e.g., UE trajectory, V2X trajectory), trace data, sensing data, network operation data (e.g., network measurement results, network profile, subscription data, configuration data, UE privacy profile, policy profile, network topology), images, text, video, audio, identity information, medical data, geographic topology and map information, crowdsourced data, network logs, network entity action record, vertical industry data such as IoT device private data (e.g. device topology and location, traffic pattern, activity mode, configuration parameters), data for actuation services, and data for radar services. The data consumer does not have the authorization to access the privacy which is included or can be inferred from the private data. DP service provider provide service to protect the privacy of the private data and prevent the leakage of data privacy to the data consumer.

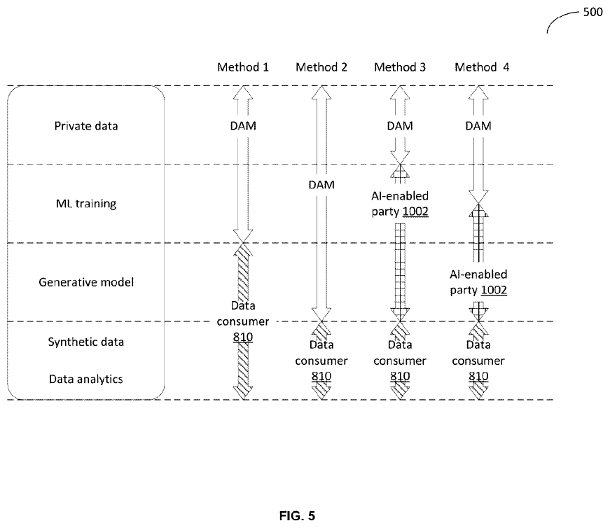

FIG. 5 illustrates a classification 500 of methods that may be used to de-privatize data and distribute or synchronize data, according to an embodiment. In a method 1, the DAM 200 which may include a DP service provider 806 or a DC service provider 1902 executes ML tasks to train a generative model and delivers the trained generative model to a data consumer 810. The data consumer 810 can use the generative model to create an unlimited amount of synthetic data 106 and perform data analytics or analysis on the synthetic data.

In a method 2, the DAM executes ML tasks to train a generative model but delivers the synthetic data 106 rather that the trained generative model to the data consumer 810. As in the type 1 model, the data consumer 810 performs data analytics based on the received synthetic data 106.

A method 3 model is similar to a method 2 model except that the DAM may offload ML tasks to an AI-enabled party 1002 to execute the ML tasks when the DAM lacks ML computing resources or lacks sufficient ML computing resources. The limitation of the type 3 model is that the AI-enabled party 1002 should be trustworthy because it needs to receive and operate on the realistic private dataset 108.

A method 4 is similar to a method 3 with the difference that the DAM and the AI-enabled party 1002 cooperates to execute the ML tasks. For example, the generative network may be trained by the AI-enabled party 1002 while the discriminative network is trained by the DAM. In this case, the potentially untrusted AI-enabled party 1002 needs not have access to the realistic private dataset 108.

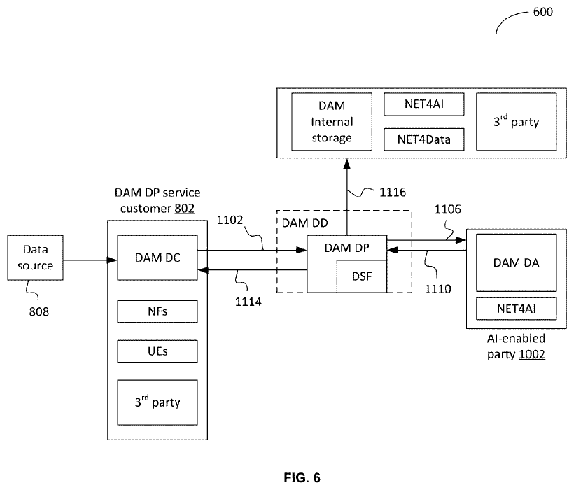

FIG. 6 illustrates an architecture 600 for data de-privatization including a data synthetization function, according to an embodiment. The DP service provider 806 of the DAM is configured with a data synthetization function (DSF) 402. Any necessary DSF tasks to produce synthetic data 106 may be executed either by the DP service provider 806 itself, or by an AI-enabled party 1002. The components of the architecture 600 all have their own responsibilities and tasks. The DP service provider 806 has the responsibility to protect the data privacy of the data source 808 customer. The DP service customer 802, which may be a DC service provider, network functions (NFs), UEs, or other 3rd parties, issue requests to the DP service provider 806 to de-privatize data and preserve the privacy of the realistic private data 108. The DC service provider is tasked with collecting data from a data source 808. The data source 808 reports data to be collected by the DC service provider. The AI-enabled party 1002, which may be a DA service provider or other party e.g., a service provider of networks for AI (NET4AI), provides AI execution or computing resources as requested by the DP service provider. The data consumer 810, such as an AI market party, a 3rd party, a NET4AI service provider, or a data market party, uses the synthetic data to perform tasks such as data analytics. The data repository, which may be DAM internal storage, provides data storage resources. The DAM data delivery (DD) service provider ensures that the data may be delivered to different players when required by the DD service customer. The data synthetization function (DSF) is as described previously, herein.

In embodiments, data source 808 can be Internet-of-things (IoT) devices such as sensors, vehicles, or UEs deployed by an operator, network, third party, or network functions (NFs) of an operator or network. The data consumer 810 may be another operator, network, or third party. The DAM 200 may be deployed in the data source's 808 home operator or network and may be a DAM-DC in a RAN, or a DAM-DP and DAM-DA in a core network (CN). The DAM may protect the data source's 808 privacy such as device topology, location, traffic pattern, activity mode, or configuration parameters, from being exposed to the data consumer 810. Data privacy can be preserved as it is more difficult to correlate the privacy with individual IoT devices from the synthetic data than from original real data.

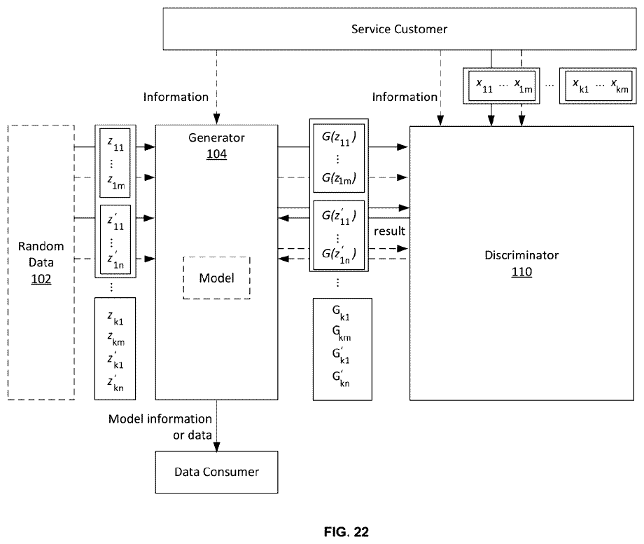

With reference to FIG. 22, the workflow to determine the generative model according to embodiment is described.

Step 1: A service customer sends a service request to a generator, for a service of data privacy protection. The service request from the service customer comprises information e.g., a preconfigured requirement of a generative model. The requirement of the generative model includes one or more of parameters: a model ID identifying the generative model; a model size of the generative model; an accuracy level to be supported by the generative model; a privacy level to be supported by the generative model; a computing or time resource requirement to establish the generative model; validity information indicating one of: valid data type to be supported by the generative model, and when or where one of the generative model and data as input to the generative model is valid; a data compression ratio to be supported by the generative model; a model type to be supported by the generative model; hyper-parameters associated with the generative model; and weights between neural network neurons associated with the generative model. The model type includes one of: a model based on a generative adversarial network (GAN), a model based on a generative neural network (GNN), a model based on an auto-encoder, and a model based on a variational auto-encoder (VAE).

Based on the service request, the generator firstly initializes and finally determines a generative model to generate synthetic data. The term determine can be also named as calculate, and select, obtain.

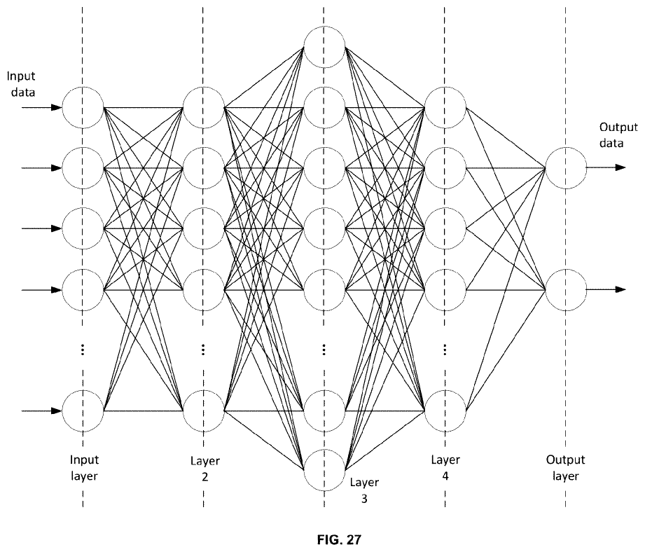

Firstly, the generator sets up and initializes a generative model. The generative model can be a neural network as in FIG. 27. The neural network is defined by hyper-parameters and parameters. The hyper-parameters includes one or more of: model type, type of input data, type of output data, number of layers, number of neurons in each layer, learning rate, and the connections between different neurons. The parameters includes the weights between neurons. The generator selects the hyper-parameters and initializes the weights between neurons to Gp0. The weights between neurons can be updated with machine learning afterwards.

Secondly, the generator can update the generative model with the assistance of a discriminator. The discriminator determines a discriminative model. The discriminator may invoke the discriminative model stored locally or in other entities based on a service request including a requirement from the service customer of the discriminative model. The discriminative model may be a trained model or a model to be trained and updated. If the discriminative model is a trained model which can be used directly to perform accurate comparison between original private data from data consumer and synthetic data from generator, the discriminator does not need to update the discriminative model any longer; otherwise, the discriminator updates the discriminative model. If the discriminator updates the discriminative model, the discriminator may set up and initialize the discriminative model based on the service request. The discriminative model can be a neural network which is same as or different from that of the generative model. The discriminator selects the hyper-parameters and initializes the weights between neurons of the neural network to Dp0. The weights between neurons can be updated with machine learning afterwards.

The generator and the discriminator may cooperatively update the generative model and discriminative model, respectively. For example, the generator uses the generative model to generate synthetic data and provides the synthetic data to a discriminator. The generator performs a comparison between data from the service customer and received synthetic data, and provides a result of the comparison to the generator, wherein the data from the service customer is associated with data privacy of the service customer. The comparison includes a comparison between a result of data analysis on the data from the service customer and a result of data analysis on the received synthetic data. The term comparison can be also named as distinguish or analysis where the discriminator performs data processing, analysis and calculation based on the data from the service customer and received synthetic data. According to the result of the comparison from the discriminator, the generator updates the generative model until updated synthetic data generated by updated generative model meets a preconfigured requirement. And each time when the generative model is updated, the generator provides newly updated synthetic data to the discriminator. The preconfigured requirement indicates at least one of: how many times the synthetic data can be generated at most, how many times the generative model can be updated at most, how much similarity is between the latest two generative models at least, an indication received from the discriminator wherein the indication indicates to provide the latest updated synthetic data or the configuration information enabling the establishment of the latest updated generative model to the data consumer, how many comparison can be performed at most, how many times the discriminative model can be updated at most, an accuracy level to be supported by the generative model, a privacy level to be supported by the generative model, and a data compression ratio to be supported by the generative model. The preconfigured requirement may be sent from the discriminator to the generator to configure the preconfigured requirement into the generator, or may be sent from the generator to the discriminator to configure the preconfigured requirement into the discriminator. The preconfigured requirement can be preconfigured into the discriminator by the service customer. For example, the preconfigured requirement is preconfigured locally when the discriminator is located in the service customer, or the preconfigured requirement is preconfigured via a message sent on an interface between the service customer and the discriminator. Then the discriminator sends the preconfigured requirement to the generator to configure the preconfigured requirement into the generator. The discriminator sends to the generator, a message indicating that the preconfigured requirement is met when times of the comparison performed by the discriminator reaches that indicated in the preconfigured requirement or when update times of the discriminative model reaches that indicated in the preconfigured requirement. Moreover, the preconfigured requirement can be preconfigured into the generator by the service customer or decided by the generator itself. Then the generator sends the preconfigured information to the discriminator to configure the preconfigured requirement into the discriminator. For example, the generator sends to the discriminator, a message indicating that the preconfigured requirement is met when times of the comparison reaches that indicated in the preconfigured requirement or when update times of the generative model reaches that indicated in the preconfigured requirement. For example, the preconfigured requirement can a condition to stop the model update e.g., model training. The condition can be include one or more of: a value K indicating the maximum numbers of model update interactions between the generator and the discriminator; the generator will not stop updating the generative model until an stop indication is received from the discriminator; the discriminator will not stop updating the discriminative model until an stop indication is received from the generator; or the generator can stop the update if the generative model is no longer significantly changed; or the discriminator can stop the update if the discriminative model is no longer significantly changed.

In embodiments, the number of generators and discriminators to cooperate are not limited. For example, one generator cooperates with one discriminator; or one generator cooperates with multiple discriminators located in the same or different places; or multiple generators located in the same or different places cooperate with one discriminator; or multiple generators located in the same or different places cooperate with multiple discriminators located in the same or different places. A hierarchical architecture is supported. One generator may output its synthetic data to one or multiple discriminators for the discriminators to update the discriminative models. One generator may receive the comparison results from one or multiple discriminators for the generator to update its generative model. Multiple generators may output their synthetic data to one or multiple discriminators for the discriminators to update the discriminative models. Multiple generators may receive the comparison results from one or multiple discriminators for the generators to update the generative models. The synthetic data output by the same generator to multiple discriminators can be same or different e.g., in each model update interaction. The comparison results output by the same discriminator to multiple generators can be same or different in each time e.g., in each model update interaction. One or more of: discriminative model parameter and comparison result, can be exchanged between discriminators. One or more of: generative model parameter and synthetic data, can be exchanged between generators.

The generator and discriminator can be located differently in different scenarios. The generator and discriminator can be located in the same entity or in different entity. For example, both the generator and discriminator can be located together in one of the entity of DP service provider, service customer or AI-enabled party; or only one of the generator and discriminator is located in one entity of the DP service provider, service customer or AI-enabled party, and the other one is located in another entity of the DP service provider, service customer or AI-enabled party; or only one of the generator and discriminator is located in one entity of the DP service provider, service customer or AI-enabled party, and the other one is located in another entity except of the DP service provider, service customer or AI-enabled party; or neither the generator nor discriminator are located in the entity of the DP service provider, service customer or AI-enabled party. The different methods may depend on whether the data consumer can trust the other parties. For example, if the data consumer only trusts itself, both the generator and discriminator can be located in the data consumer, or the discriminator which needs to access original private data is located in the data consumer while the generator which need not access original private data is located in another untrusted party e.g. the DP service provider. If the data consumer trusts the DP service provider, both the generator and discriminator can be located in the DP service provider, or the discriminator is located in the DP service provider while the generator is located in an untrusted party e.g. the AI-enabled party. If the data consumer trusts the AI-enabled party, both the generator and discriminator can be located in the AI-enabled party, or the discriminator is located in the Ai-enabled party while the generator is located in an untrusted party.

In an embodiment, the generator is located in a first entity which has no interface supporting a transmission of the service request from the service customer, the discriminator is located in a second entity which has an interface supporting a transmission of the service request from the service customer, wherein the generator receives the service request from the service customer via the discriminator. The first entity can be the AI-enabled party 1002, and the second party can be the DP service provider 806. The discriminator, receives a set of parameters from the service customer. The discriminator determines the discriminative model according to the set of parameters. The set of parameters may include a requirement of the discriminative model. The requirement of the discriminative model includes one or more of parameters: a model ID identifying the discriminative model; a model size of the discriminative model; an accuracy level to be supported by the discriminative model; a privacy level to be supported by the discriminative model; a computing or time resource requirement to establish the discriminative model; validity information indicating one of: valid data type to be supported by the discriminative model, and when or where one of the discriminative model and data as input to the discriminative model is valid; a model type to be supported by the discriminative model; hyper-parameters associated with the discriminative model; and weights between neural network neurons associated with the generative model. The model type includes one of: a model based on a generative adversarial network (GAN), a model based on a generative neural network (GNN), a model based on an auto-encoder, and a model based on a variational auto-encoder (VAE). The generator located in the AI-enabled party 1002 receives from the DP service provider 806, a split indication indicating that a generative model is required to output data for a comparison performed by a discriminative model. The generator determines the generative model according to the split indication. For example, the split indication includes one or more parameters including: strings e.g. “generative model only” or Boolean value “1” indicating that only a generative model needs to be determined, a task type indicating that a generative model to be determined; a private data type indicating the type of the private data of the service customer to enable generator to generate a suitable type of synthetic data and the data type may be text, figure, audio, video, sensing data, and wireless network structured or unstructured data; an intermediate data requirement indicating the requirement on the intermediate data to be output from generator to discriminator during the model update procedure, and the output intermediate data can be samples of the synthetic data generated during the model training procedure, and the intermediate data requirement may include a data format, number of data samples. The generative model can be determined using methods as defined for the GNN, GAN, VAE or auto-encoder. If the model type is not included in the service request, the generator can itself decide the specific method to determine the method e.g., based on other parameters included in the service request.

A requirement of a generative model can be received by the generator located in the AI-enabled party 1002 from the discriminator located in the DP service provider 806. The requirement of the generative model includes one or more of parameters: a model ID identifying the generative model; a model size of the generative model; an accuracy level to be supported by the generative model; a privacy level to be supported by the generative model; a computing or time resource requirement to establish the generative model; validity information indicating one or more of: valid data type to be supported by the generative model, and when or where one of the generative model and data as input to the generative model is valid; a data compression ratio to be supported by the generative model; a model type to be supported by the generative model; hyper-parameters associated with the generative model; and weights between neural network neurons associated with the generative model. The model type includes one of: a model based on a generative adversarial network (GAN), a model based on a generative neural network (GNN), a model based on an auto-encoder, and a model based on a variational auto-encoder (VAE). Moreover, the preconfigured requirement is aligned as mentioned above between the generator and the discriminator. The DP service provider 806 may send the preconfigured requirement to the generator located in the AI-enabled party 1002 to configure the preconfigured requirement into the generator.

In an embodiment, the generator is located in a first entity which has interfaces supporting a transmission of the service request from the service customer, the discriminator is located in the service customer. The first entity can be the DP service provider 806 or the AI-enabled party 1002. The generator located in the provider 806 or provider 806 receives the service request from the service customer. The service request may comprise the requirement of a generative model. The service request may include a split indication indicating that a generative model is required to output data for a comparison performed by a discriminative model. The service customer determines the discriminative model according to a local stored set of parameters. The local stored set of parameters can be as mentioned above. Moreover, the preconfigured requirement is aligned as mentioned above between the generator and the discriminator. The service customer may send the preconfigured requirement to the generator to configure the preconfigured requirement into the generator. For example, the preconfigured requirement may be a condition to stop the model update e.g., model training. The condition can include one or more of: a value K indicating the maximum numbers of training interactions between the DP service provider 806 and the service customer; the model training of the generator will not stop until an stop indication is received from the service customer; or the DP service provider 806 can stop the model training if the generative model is no longer significantly changed.

In an embodiment, the generator and the discriminator are located in an entity, wherein the service request is received by the entity from the service customer. The entity is a DP service provider 806 whose interface with the service customer supports a transmission of one or more of the service request and the data. Or the entity has an interface with a DP service provider and no interface with the service customer, while the DP service provider has an interface supporting a transmission of one or more of the service request and the data with the service customer, and the service request is received by the entity from the service customer via the DP service provider, and the entity can be the AI-enabled party 1002. The DP service provider 806 is configured to determine how to generate the generative model and the discriminator model according to the service request. Moreover, the preconfigured requirement is aligned as mentioned above between the generator and the discriminator. For example, the DP service provider 806 may send the preconfigured requirement to the generator and the discriminator to configure the preconfigured requirement into the generator and the discriminator.

In an embodiment, the generator and the discriminator are located in the service customer. The service customer performs the data protection function locally using the generator and the discriminator locations. The service customer may send the service request and preconfigured requirement to one or more of the generator and the discriminator. After the preconfigured requirement is met, the service customer sends at least one of: latest updated synthetic data, and configuration information enabling an establishment of the latest updated generative model which generated the latest updated synthetic data to the data consumer.

Step 2: Once the preconfigured requirement is met, the generator provides to a data consumer, at least one of: the latest updated synthetic data which meets the preconfigured requirement, and configuration information enabling an establishment of the latest updated generative model which generated the latest updated synthetic data, wherein the data consumer has no authorization to access the privacy which is included or can be inferred from the data from the service customer. To enable the generator to identify the data consumer, the service request from the service customer may comprise a data consumer identifier that identifies the data consumer. The data consumer needs to use the data from the service customer to perform a mission e.g., data analysis, AI training, or AI inference. The data consumer has no authorization to access the service customer's privacy which is included in or can be inferred from the original data from the service customer. The privacy of the service customer includes one or more of: identifier, location, trajectory, activity, biometric and other information that the service customer does not want to be exposed to the data consumer. The latest updated synthetic data which meets the preconfigured requirement excludes privacy of the service customer. For example, the privacy of the service customer cannot be inferred by the data consumer via analyzing the latest updated synthetic data. In the latest updated synthetic data, the sensitive and private data information of the original data from the service customer has been removed, filtered, hidden, or replaced. At the same time, the data consumer still can perform the mission with the synthetic data or the generative model. The performance of the synthetic data or the generative model is same as or close to that of the original data when the synthetic data or the generative model is used in place of the original data by the data consumer to perform the mission.

In embodiments, once the preconfigured requirement is met, the generator can also provide to the service customer, at least one of: the latest updated synthetic data which meets the preconfigured requirement, and configuration information enabling an establishment of the latest updated generative model which generated the latest updated synthetic data. Then the service customer decides to provide to a data consumer, at least one of: the latest updated synthetic data which meets the preconfigured requirement, and configuration information enabling an establishment of the latest updated generative model which generated the latest updated synthetic data.

The configuration information for the establishment of the latest updated generative model comprises one or more descriptions of a generative model: a model ID identifying the generative model; a model size of the generative model; an accuracy level supported by the generative model; a privacy level supported by the generative model; a computing or time resource requirement to establish the generative model; validity information indicating one of: valid data type supported by the generative model, and when or where one of the generative model and data as input to the generative model is valid; and a data compression ratio supported by the generative model. The validity information includes one or more of: time information indicating at which time one of the generative model and data as input to the generative model is valid, a time period indicating during which time period one of the generative model and data as input to the generative model is valid, location information indicating within which area one of the generative model and data as input to the generative model is valid; and a requirement on one of a valid data source and a valid operation platform. The area indicated by the location information includes one of: a public land mobile network (PLMN); a non-public network (NPN); an area related to a network slice; a tracking area (TA) of a terminal; and a network cell. The requirement includes one of parameters of following data source of the generative model or operation platform of the generative model: a user equipment (UE); a data source type; a radio access network (RAN) node; and a network function (NF). The configuration information for the establishment of the latest updated generative model may comprise: weights between neural network neurons associated with the latest updated generative model; and hyper-parameters associated with the latest updated generative model. The configuration information for the establishment of the latest updated generative model may also comprise the assistant data which needs to be input data: The generative model is not useable if the validity information is violated.

The configuration information of the latest updated synthetic data can be also provided to the data consumer if the generator provides the latest updated synthetic data to a data consumer. The configuration information of the latest updated synthetic data comprises one or more descriptions of the synthetic data: a size of the synthetic data; an accuracy level supported by the synthetic data; a privacy level supported by the synthetic data; validity information indicating one of: when or where the synthetic data is valid; and a compression ratio between the synthetic data and the original data. The validity information includes one or more of: time information indicating at which time the synthetic data is valid, a time period indicating during which time period the synthetic data is valid, location information indicating within which area the synthetic data is valid; and a requirement on one of a valid data source and a valid operation platform. The area indicated by the location information includes one of: a public land mobile network (PLMN); a non-public network (NPN); an area related to a network slice; a tracking area (TA) of a terminal; and a network cell. The requirement includes one of parameters of following data source of the synthetic data or operation platform of the synthetic data: a user equipment (UE); a data source type; a radio access network (RAN) node; and a network function (NF). The synthetic data is not useable if the validity information is violated.

In embodiments, as in FIG. 22 and FIG. 27, the generative model and the discriminative model can be respectively determined by the generator and the discriminator as follows.

### 1. Model Initialization:

The discriminator sets up the discriminative model and initialize the model parameter Dp. The generator sets up the generative model and initialize the model parameter Gp. For example, the discriminative model and the generative model can be neural networks as in FIG. 27. The discriminative model can be same to or different from the generative model.
The discriminative model in discriminator
   input data: private real data x from service customer or synthetic data from generator i.e., the output data G(z) of the generative model. There may be also assistant data input into the discriminative model.
   output data: the estimated probability that the current input data is the real data from the service customer i.e., D(x) indicating the estimated probability by the discriminator that the current input data x is from service customer, or D(G(z)) indicating the estimated probability by the discriminator that the current input data G(z) is from service customer.

The output data may also include the estimated probability that the current input data is not the real data from the service customer i.e., 1−D(x) or 1−D(G(z));
The generative model in generator
   input data: random z which has a random distribution such as Gaussian noise or a uniform distribution. There may be also assistant data input into the generative model.
   output data: synthetic data G(z).

### 2. Model Update:

Update procedure of the discriminative model by discriminator
   a) Discriminator receives sample of private real data xₖᵢ from service customer and feeds xₖᵢ into the generative and calculates the output D(xₖᵢ)
   b) Given the generative model, generator feeds random sample zₖᵢ into the generative model and calculates the output G(zₖᵢ), then generator sends G(zₖᵢ)) to discriminator and discriminator feeds G(zₖᵢ) into discriminative model and calculates the output D(G (zₖᵢ))
   c) Based on xₖᵢ and G(zₖᵢ), discriminator updates the discriminative model parameter Dp. For example, discriminator updates the discriminative model parameter such that the probability that the discriminative model can correctly determine whether the current input data is real or not is maximized e.g. to update Dp to maximize the value of D(xₖᵢ)+1−D(G (zₖᵢ)) or log(D (xₖᵢ))+log(1−D(G(zₖᵢ)))
   d) Repeat the steps from a) to c) for m times, continue updating discriminative model parameter Dp, and go to the following update procedure of the generative model. It should be noted that the value of xₖᵢ and zₖᵢ in different steps can be changed.
Update procedure of the generative model by generator
   e) Given the discriminative model in discriminator, generator feeds random sample z′ⱼₖ into the generative model and calculates the output G(z′ₖⱼ), then generator sends G(z′ₖⱼ) to discriminator and discriminator feeds G(z′ₖⱼ) into discriminative model and calculates the output D(G(z′ₖⱼ)). Discriminator sends the output D(G(z′ₖⱼ)) to generator.
   f) Given the D(G(z′ₖⱼ)), generator updates the generative model Gp. For example, generator updates the generative model parameter such that the probability that the discriminative model in discriminator can correctly determine whether the current input synthetic data is not real data from service customer is minimized e.g. to update Dp to minimize the value of 1−D(G(z′ₖᵢ)) or log(1−D(G(z′ₖᵢ)))
   g) Repeat the steps from e) to f) for n times, continue updating generative model parameter Gp, and then go to the above update procedure of discriminative model, i.e., repeat the steps from a) to f) until the preconfigured information is met and stop the model update procedure e.g. repeat the steps from a) to f) for k times. Then the generative model and the discriminative model are determined.

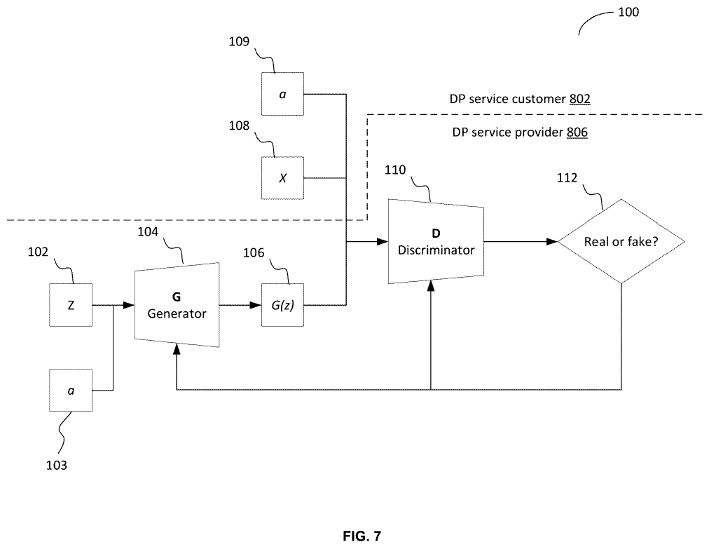

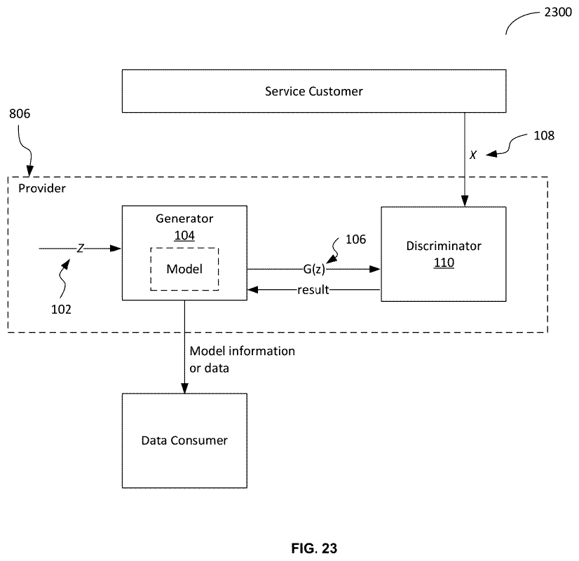

FIG. 7 illustrates how a DAM 200 may execute all required data synthetization function (DSF) 402 tasks, according to an embodiment. The generator 104 and the discriminator 110 are located in the DP service provider as illustrated in FIG. 23. In this embodiment, the DP service customer 802 also provides real data 108 and assistant data 109 for the DP service provider. DP service provider 806 is then responsible for executing the whole DSF e.g., to train the generative model by the generator 104 and the discriminative model by the discriminator 110 of the GAN 100. The resulting synthetic data 106 and/or the configuration information enabling an establishment of the generative model which generated the synthetic data may then be returned to the DP service customer 802 or to other authorized parties e.g., the data consumer. There is an interface which supports a transmission of one or more of the service request and the private data between the DP service customer and the DP service provider. After receiving the service request from the service customer, the DP service provider is configured to determine how to generate the generative model and the discriminator model according to the service request. For example, the service request from the service customer includes a requirement for a generative model and the generative model determined by the generator meets the requirement of the generative model. The requirement of the generative model can include one or more of: a model ID identifying the generative model; a model size of the generative model; an accuracy level to be supported by the generative model; a privacy level to be supported by the generative model; a computing or time resource requirement to establish the generative model; validity information indicating one or more of: valid data type to be supported by the generative model, and when or where one of the generative model and data as input to the generative model is valid; a data compression ratio to be supported by the generative model; a model type to be supported by the generative model; hyper-parameters associated with the generative model; and weights between neural network nodes associated with the generative model. The model type includes one of: a model based on a generative adversarial network (GAN), a model based on a generative neural network (GNN), a model based on an auto-encoder, and a model based on a variational auto-encoder (VAE). Based on the requirement of the generative model, the DP service provider can be configured to determine how to generate the generative model. For example, based on the model ID, DP service provider specific information on the generative model e.g. the hyper-parameters associated with the generative model. Based on the privacy level and the accuracy level, the DP service customer can itself decide the model type and the related hyper-parameters which can support the privacy level and accuracy level. Based on the validity information, the DP service provider can decide what private data can be used to train the generative model.

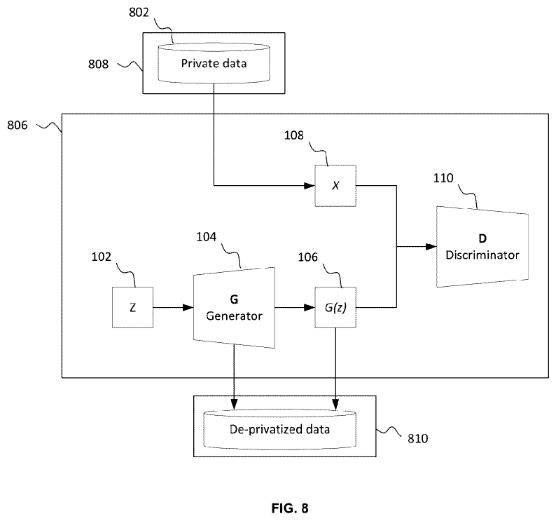

FIG. 8 illustrates how a DP service customer 802 may provide private data to a DAM-DP, and how the DAM-DP may output de-privatized data e.g., synthetic data 106 or a generative model to a data consumer 810, according to an embodiment. The generator 104 and the discriminator 110 are located in the DP service provider as illustrated in FIG. 23. DP service customer 802 provides private data which includes real data 108 to be used for training the generative model by the generator 104 and the discriminative model by the discriminator 110 of the GAN 100 of DP service provider 806. De-privatized synthetic data 106 and/or the configuration information may be supplied back to the DP service customer 802 or to a third party. The model of FIG. 8 may be used when a DP service customer 802 has data that is of value to other parties but where the real data is proprietary or confidential and may not be shared as is. The DP service customer 802 may contract to the DP service provider 806 to obtain synthetic data 106 of a similar distribution to the real data and provide the synthetic data 106 to others as a service.

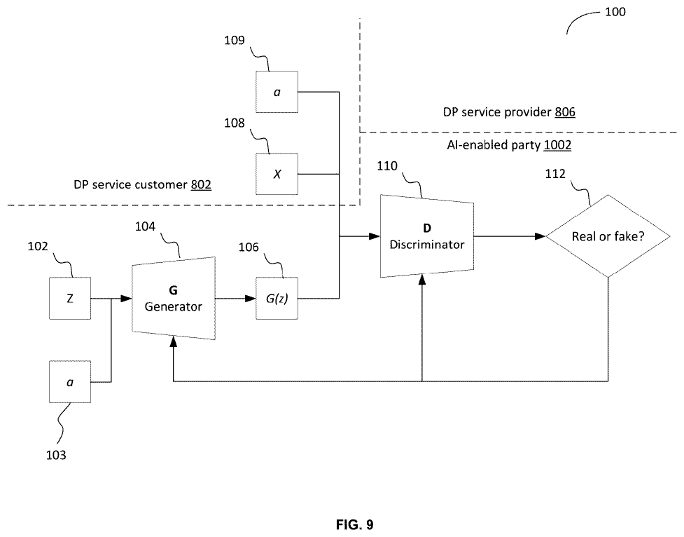

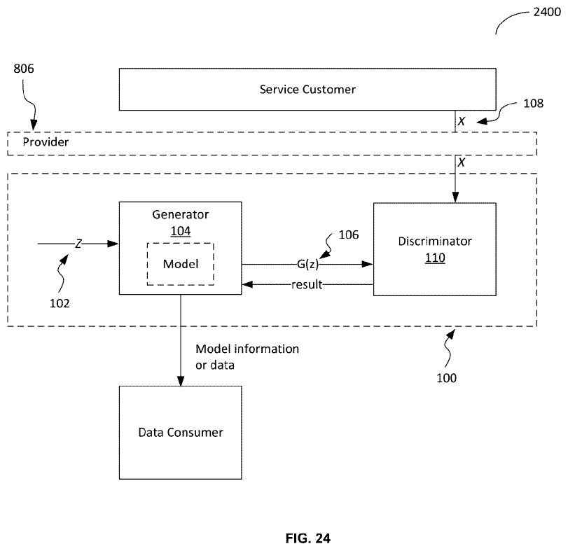

Together with reference to FIG. 24, FIG. 9 illustrates how an AI-enabled party 1002 may help a DAM 200 to execute all required DSF 402 tasks, according to an embodiment. In this embodiment, the DP service provider 806 does not have the AI resources to conduct the training of the generator 104 or the discriminator 110 so obtains the services of an AI-enabled party 1002 to perform the required calculations. The division of tasks between the DP service customer 802, the DP service provider 806, and the AI-enabled party 1002 is illustrated with a dashed line. The real data 108 training set must be shared with the AI-enabled party 1002 so a sufficient level of trust between the DP service customer 802, the DP service provider 806, and the AI-enabled party 1002 must exist for this model to be viable. The AI-enabled party has an interface with a DP service provider and no interface with the service customer, while the DP service provider has an interface supporting a transmission of one or more of the service request and the data with the service customer, and at least some of the information included in the service request may be received by the AI-enabled party from the service customer via the DP service provider.

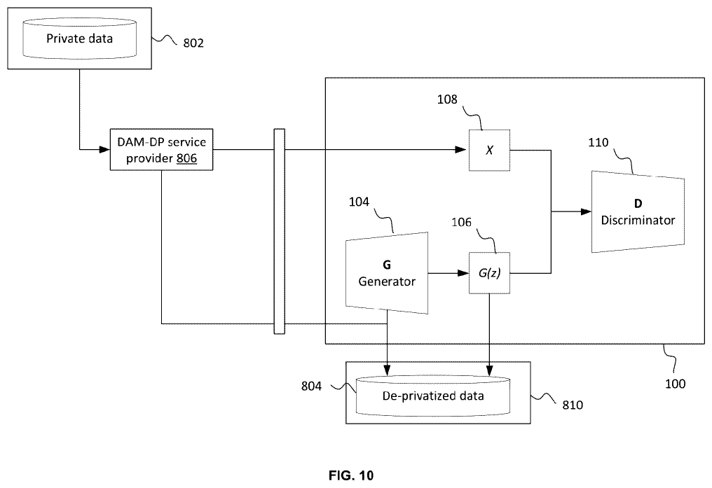

Together with reference to FIG. 24, FIG. 10 illustrates how a DP service customer 802 may provide data to a DAM-DP when the DP requests help of an AI-enabled party 1002, and the AI-enabled party 1002 outputs de-privatized data e.g., synthetic data 106 or the configuration information to the DAM-DP, or to a data consumer 810, according to an embodiment. The AI-enabled party 102 may have an interface with a DP service provider and no interface with the service customer, while the DP service provider has an interface supporting a transmission of one or more of the service request and the data with the service customer, and the service request is received by the AI-enabled party 102 from the service customer via the DP service provider. The generator and the discriminator are located in the AI-enabled party 102. DP service customer 802 provides private data 802 which includes real data 108 to be used for training the generator 104 and discriminator 110 of the GAN 100 to DAM-DP service provider 806. The DP service provider 806 sends the real data 108 to a GAN 100 of the AI-enabled party 1002. De-privatized synthetic data 106 may be supplied back through the DP service provider 806 to the DP service customer 802 or to a third party. The model of FIG. 10 may be used when a DP service customer 802 had data that is of value to other parties but where the real data is proprietary or confidential and may not be shared. The DP service customer 802 may contract to the DP service provider 806 to obtain synthetic data 106 of a similar distribution to the real data and provide the synthetic data to others as a service. The real data 108 of the training set must be shared with the AI-enabled party 1002 so a sufficient level of trust between the DP service customer 802, the DP service provider 806, and the AI-enabled party 1002 must exist for this model to be viable.

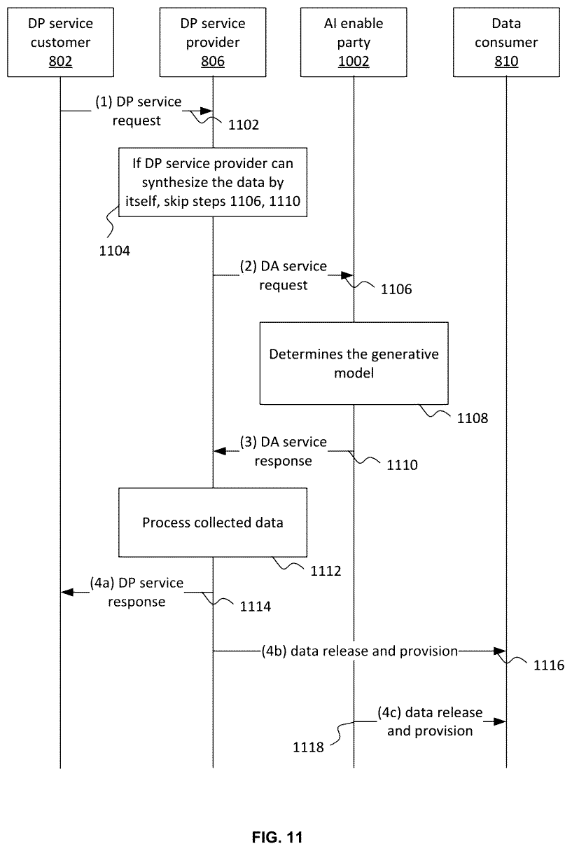

FIG. 11 illustrates a method where a DAM 200 executes required DSF 402 tasks and the generator and the discriminator are located in the DP service provider, or an AI-enabled party 1002 helps the DAM 200 to execute the required DSF 402 tasks and the generator and the discriminator are located in the AI-enabled party, according to an embodiment. In step 1102, a DP service customer 802, which may be a DAM DC service provider, NFs, UEs, or a 3rd party, sends a DP service request message 1102 to a DP service provider 806. The service request from the service customer may comprise information e.g., the requirement and/or the preconfigured requirement on a generative model. Based on the service request, the generator firstly initializes and finally determines a generative model to generate synthetic data. The DP service request message 1102 may include one or more parameters including data de-privatization requirements (e.g., data privacy levels), DSF requirements (e.g., DSF ID), synthetic data requirements (e.g., data synthetic accuracy, or a synthetic dataset size which indicates the specific or minimum amount of synthetic data needed to be transmitted back), a synthetic data indication, a synthetic method (e.g., GANs, GNN and VAE), or an address to receive produced synthetic data. The service request message 1102 may be used to indicate that synthetic data 106 needs to be generated for realistic data 108 of the training set. The service request message 1102 may also be used to indicate requirements for data to be used for synthesizing data (e.g., samples of realistic data, samples of labeled data, samples of unlabeled data, and other data (e.g., latent parameter, conditional parameter, denial constraints, and auxiliary parameter) that may need to be used for the ML procedure). Data requirements may be transmitted within the DP service request message 1102 or after the DP service request message 1102.

In embodiments, different qualities of data synthetization services can be provided to customers in terms of data synthetic accuracy level, privacy level, data model type, data synthetization delay, data model validity information etc. Different qualities of data synthetization services can be pre-configured and aligned among data source 808, DC service provider 1902, AI enabled external party 1002, data consumer 810, and DP service provider 806, as per a service agreement. Different qualities of data synthetization services can be implemented with different DSF instances and can be identified with DSF IDs. This detailed information can include information such as data synthetic accuracy level, privacy level, data model type, data synthetization delay, data model validity information for a data synthetization service, a choice between synthetic dataset or data, and other information. It can reduce interaction complexity and overhead required to indicate the detailed service request or the detailed information of a synthetic dataset, generative model or data model using the DSF ID instead of with a large number of parameters. A data synthetization function (DSF) ID may indicate the detailed service requirements for data synthetization. A data synthetization indication may indicate that a data synthetization service is needed. A data synthetization accuracy level may indicate an achievable specific or minimum performance accuracy by using synthetic data, a generative model or a data model in place of private data. A data synthetization privacy level may indicate an achievable specific or minimum degree to protect the privacy of private data by using synthetic data, a generative model or a data model in place of the private data. A dataset size may indicate a specific or minimum amount of synthetic data to be generated, or a synthetic method.

In step 1104, the DP service provider 806 determines if it has the AI/ML computing resources required to execute the DSF itself e.g., to determine a generative model or to a synthesize data itself, or whether it must utilize a separate AI enabled party 1002 for AI/ML computing resources. If the DP service provider 806 can synthesize the data or determine the generative model by itself then the DP service provider 806 de-privatizes the data itself and may skip steps 1106, 1108, and 1110.

If the DP service provider 806 is unable to provide AI/ML computing services to synthesize data itself, then in step 1106, the DP service provider 806 sends a DA service request message 1106 to the AI enable party 1002, which may be a DA service provider. The service request from the DP service provider may comprise information e.g., the requirement and/or the preconfigured requirement on a generative model. The DA service request message 1106 may include one or more parameters including data analytics requirements (e.g., analysis delay), DSF requirements (e.g., DSF ID), synthetic data requirements (e.g., specific, or minimum data synthetic accuracy, specific or minimum data synthetic accuracy level, privacy level, specific or minimum data synthetic accuracy, synthetic dataset size), a synthetic data indication, or specific synthetic methods (e.g., GANs, GNN and VAE) to be used. The DA service request message 1106 may be used to indicate that synthetic data needs to be generated for the realistic dataset specified in the DP service request message 1106. The DA service request message 1106 may also be used to specify requirements for the data that may be used for synthesizing data (e.g., samples of realistic data, samples of labeled data, samples of unlabeled data, and assistant data (e.g., latent parameter, conditional parameter, denial constraints, and auxiliary parameter) that may be needed during ML procedure) which may be transmitted in the DA service request message 1106 or after the DA service request message 1106.

In order to preserve security and the privacy of the realistic data 108, the AI-enabled party 1002 should be trustworthy to the owner of the data, since in this embodiment it may be required to transmit realistic data 108 to the AI-enabled party 1002 in order to synthesize the synthetic data 106. In embodiments, realistic data 108 may also be protected by additional privacy-preserving methods including differential privacy, homomorphic encryption, secure multi-party computation, trusted execution environment, and secure enclaves.

In step 1108, the AI-enabled party 1002 determines the generative model. For example, the AI-enabled party 1002 (e.g., a DA service provider) executes AI tasks such as GAN training tasks required to produce a generative model 104 and to generate synthetic data 106. The AI-enabled party 1002 executes the DSF 402 tasks based on the requirements of the DP service provider 806 to obtain the synthetic data 106 or the data model (e.g., generative model) information. The data model information may include one or more parameters such as a model parameter, a model hyper-parameter (e.g., variable z distribution), and other parameters (e.g., latent parameter, conditional parameter, denial constraints, and auxiliary parameter), specific and minimum computing and/or time resource requirement to compute the data model, or model validity information (e.g., valid time, valid scope e.g., specific public land mobile networks (PLMNs), Non-Public Networks (NPNs), slices, Tracking Areas (TAs), cells, UEs or valid area e.g., geographic region, or a valid data source type (e.g., mobile terminal, vehicle, UE type 1, UE type 2, vehicle type 1, vehicle type 2)). The data model type can indicate data model information. Sending the model type rather than detailed model parameters can reduce the overhead between the DC service provider and the AI-enabled party 1002.

The AI-enabled party 1002 (e.g., a DAM DA service provider) sends a DA service response message 1110 to the DP service provider 806. The DA service response message 1110 may include one or more parameters such as a synthetic data indication, a data model (e.g., generative model) indication, a synthetic data size, a data model (e.g., generative model) size, a data model type ID, an indication of the synthetic data accuracy, a DSF ID, or a privacy level. The AI-enabled party 1002 may send the synthetic data 106 or the data model (e.g., generative model) information to the DP service provider 806 with the DA service response message 1110 or after the DA service response message 1110. One or more of: the synthetic data 106 or the configuration information may be delivered to DP service provider by AI enabled party.

In step 1112, the DP service provider 806 processes collected realistic data, including data de-privatization services, data synthesizing, and labelling. For data de-privatization services, the function of the data model (e.g., generative model) is used to de-privatize data, by generating the synthetic data with the required characteristics, such as semantic feature of the realistic data. In this way, synthetic data instead of the realistic data may be exposed to data consumer 810. Step 1112 may be skipped if steps 1106, 1108 and 1110 have been executed.

In embodiments, the generative model can be trained with privacy-preserving methods including differential privacy, homomorphic encryption, secure multi-party computation, trusted execution environment, and secure enclaves. The DP service provider 806 sends a DP service response message 1114 to the DP service customer 802. The message is to indicate the transmission of the synthetic data 106 or the data model (e.g., generative model) information. The data model information may comprise the configuration information enabling an establishment of the latest updated generative model which generated the latest updated synthetic data. The DP service response message 1114 may include one or more parameters such as synthetic data information (e.g., synthetic data size, data model size, synthetic data accuracy, privacy level), or a DSF ID. If the DP service provider 806 has executed the DSF itself, it may forward the synthetic data and/or data model (e.g., generative model) information to the DP service customer 802. If the DP service provider 806 has received the synthetic data from the AI-enabled party 1002, it may forward the synthetic data to the DP service customer 802. If the DP service provider 806 has received data model (e.g., generative model) information, it may generate the synthetic data using the data model and then forwards the synthetic data to the DP service customer 802. The DP service provider 806 may be configured to forward the data model to the DP service customer 802. One or more of: the synthetic data 106 and the configuration information may be delivered to DP service provider by AI enabled party.

Optionally, the DP service provider 806 may send a data release and provision message 1116 to a data consumer. The message is to indicate the transmission of the synthetic data 106 or the data model (e.g., generative model) information. The data model information may comprise a configuration information enabling an establishment of the latest updated generative model which generated the latest updated synthetic data. The DP service provider 806 may directly store the synthetic data 106 or the data model (e.g., generative model) information, or both the synthetic data 106 and the data model into DAM internal storage or forward it to the data consumer 810 for further use. One or more of: the synthetic data 106 and the configuration information may be delivered to the data consumer by DP service provider.

Optionally, the AI-enabled party 1002 may send a data release and provision message 1118 to the data consumer. The AI-enabled party 1002 may directly store the synthetic data 106, the data model (e.g., generative model) information, or both the synthetic data 106 and the data model into the DAM internal storage or forward it to data consumer 810 for further use. One or more of: the synthetic data 106 and the configuration information may be delivered to the data consumer by the AI-enabled party 1002.

In embodiments, the DP service provider 806 and AI-enabled party 1002 may be deployed separately or integrated together.

In embodiments, messages and data may be transmitted with the assistance of a DAM DD service provider.

Embodiments may be used in a cellular network environment with multiple deployments. For example, the DP service provider may be deployed within a radio access network (RAN) and the AI-enabled party 1002 may be deployed within the core network (CN) or within the Operations Administration and Maintenance (OAM). A DP service provider 806 may be pre-configured and pre-store different GANs in its algorithm library for different use cases. Multiple DSF instances with different abilities may be deployed flexibly over the whole network, for example integrated with or separated from network functions (NFs), RANs, and devices.

In embodiments, the DP service provider 806 can de-privatize data by itself or with the help of an AI-enabled party 1002. DSF tasks to synthesize data are executed by a DP-service provider 806 or an AI-enabled party 1002. Embodiments allow flexible data sharing with a data synthetization mechanism, especially in an open ecosystem. The de-privatized data (i.e., the synthetic data 106) can be shared with any third party while preserving the privacy of the realistic data 108. Specifically, embodiments allow for intra-network, inter-network, and operator data sharing (e.g., network topology, UE location, UE trajectory) in multi-player ecosystems. At the same time, the data transmission overhead for data sharing can be reduced, by sharing and transmitting the generative model 104 instead of the original data 108 or the synthetic data 106.

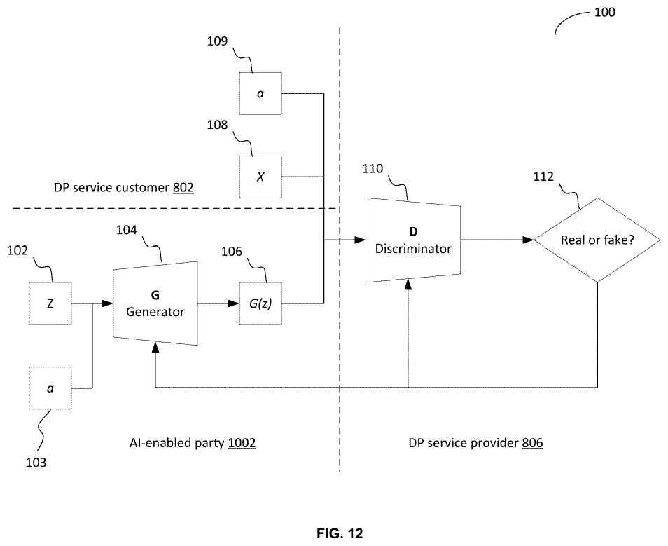

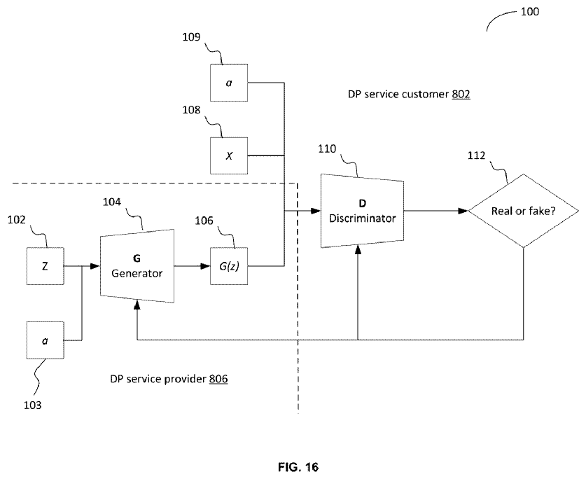

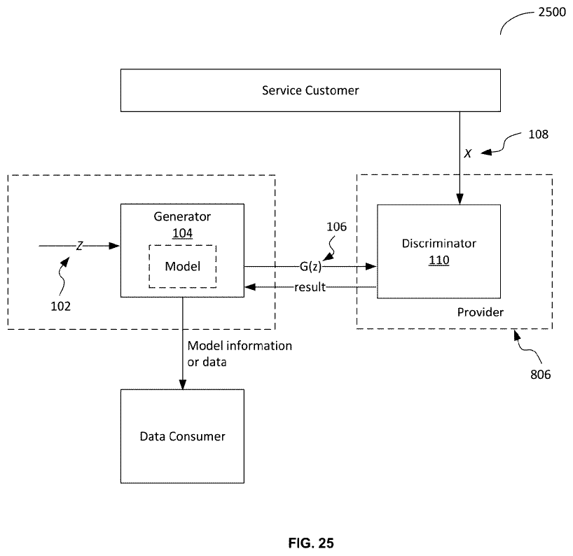

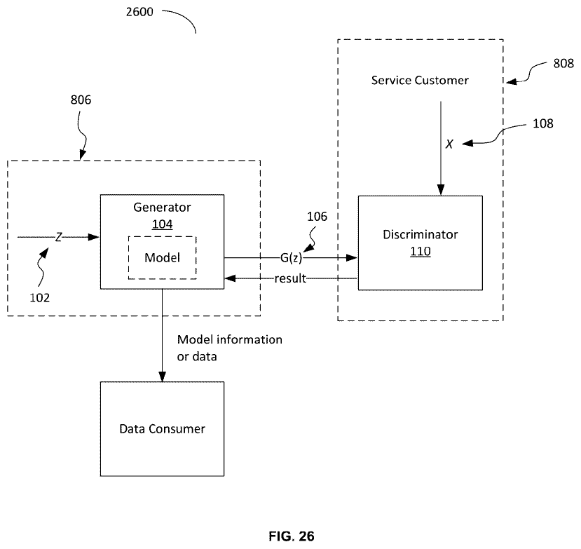

Together with reference to FIG. 25, FIG. 12 illustrates function splitting among a DP service customer 802, a DP service provider 806, and an AI-enabled party 1002, according to an embodiment where the AI-enabled party 1002 is not trustworthy from the point of view of preserving the privacy of the realistic data 108. The AI-enabled party 1002 is prevented from accessing the realistic data 108 which is only accessible to the DP service customer 802, that is the owner or provider of the realistic data 108, and the DP service provider 806, that is trusted by the DP service customer 802. The AI-enabled party 1002 has access to the random distribution data and assistant data with which to train the generator 104. As illustrated, the dashed line indicates which section of the GAN 100 is accessible to the DP service customer 802, the DP service provider 806, and the AI-enabled party 1002. The discriminator is located in the DP service provider and the generator is located in the AI-enabled party. The DP service customer 802 supplies realistic data 108 and the DP service provider 806 uses the realistic data 108 to train the discriminator 110 and the real or fake decision function 112. In FIG. 1, FIG. 3, FIG. 9, FIG. 12 and FIG. 16, the real or fake decision function 112 can be simplified to the output result of the discriminator 110 as in FIG. 21, FIG. 22, FIG. 23, FIG. 24, FIG. 25 and FIG. 26. At the same time, the output result of the discriminator 110 as in FIG. 21, FIG. 22, FIG. 23, FIG. 24, FIG. 25, and FIG. 26 can be decided by the real or fake decision function 112 as in FIG. 1, FIG. 3, FIG. 9, FIG. 12 and FIG. 16. The output result of the discriminator 110 could be a complex function of both the synthetic data and the data from the service customer, a probability that the current input data of the discriminator is real or fake, or a simple value e.g. Boolean value to indicate the current input data of the discriminator is real or fake. The discriminator and generator as in FIG. 21, FIG. 22, FIG. 23, FIG. 24, FIG. 25 and FIG. 26 may also receive assistant data 103 from the service customer as in FIG. 1, FIG. 3, FIG. 9, FIG. 12 and FIG. 16. In general, parts of the DSF tasks which need to use the private realistic data 108 should be executed by DP service provider 806, and the other parts of the DSF tasks are executed by the AI-enabled party 1002, or the DP service provider 806 and an AI-enabled party 1002 cooperating together in a manner that preserves the privacy of the realistic data 108. Using the example of the GAN 100 of FIG. 1 as an example, FIG. 12 illustrates the task split between the DP service provider 806 and the AI-enabled party 1002. The DP service customer 802 owns the realistic data 108 and provides the samples of the realistic data 108 to DP service provider 806 for data de-privatization. The DP service provider 806 executes the DSF 402 tasks that need access to the realistic data 108, such as training the discriminator network 110, while the AI-enabled party 1002 executes the other DSF tasks, such as training the generative network 104.

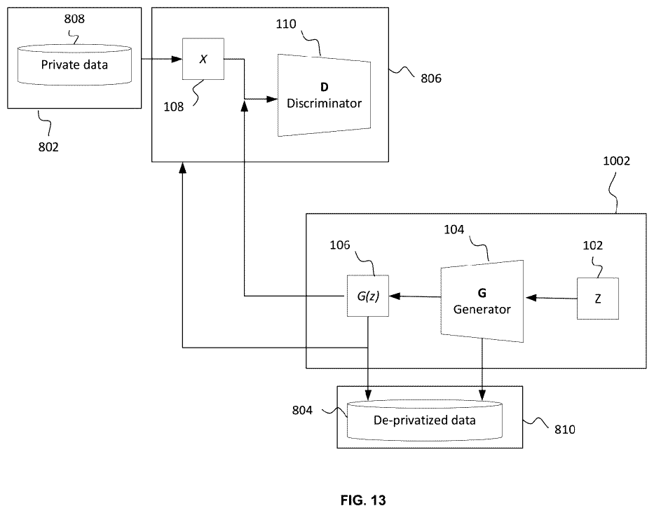

Together with reference to FIG. 25, FIG. 13 illustrates how a DP service customer 802 may supply private data to a DP service provider 806 and the DP service provider 806 executes the discriminator 110 training tasks while an AI-enabled party 1002 executes the generator 104 training tasks, according to an embodiment. The discriminator is located in the DP service provider and the generator is located in the AI-enabled party. Private realistic data is owned or controlled by a DP service customer 802 and may be stored locally to the DP service customer 802 in local storage 808. The DP service customer 802 has a sufficient degree of trust with a DP service provider 806 and shares the realistic data 108 with the DP service provider 806 in order for the DP service provider 806 to train discriminator 110. AI-enabled party 1002, which may not be trusted by the DP service customer 802 to access realistic data 108, trains generator 104 to produce synthetic data 106. The generative model, the synthetic data 106, or both the generative model and the synthetic data 106 may be stored with a Data consumer 810 in storage 804 for de-privatized data.

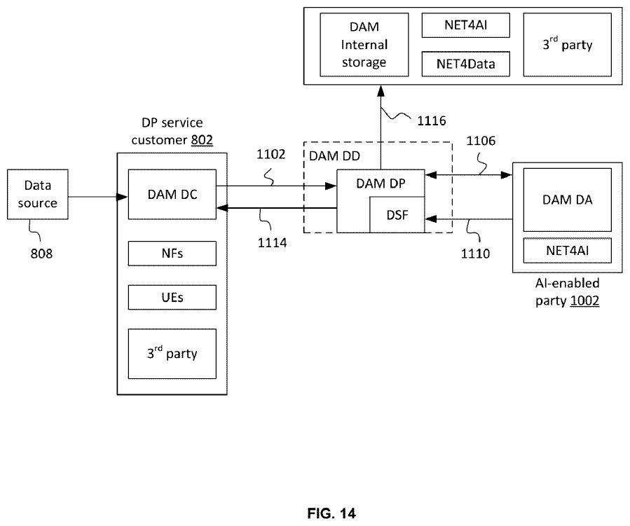

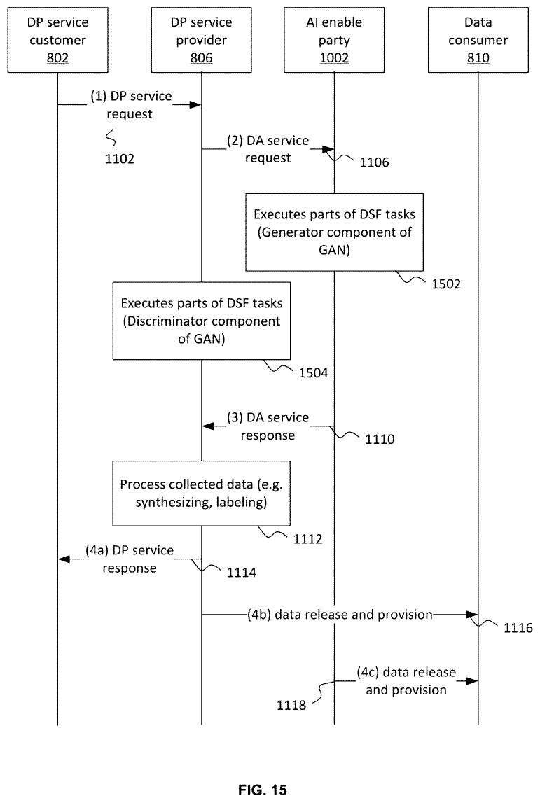

FIG. 14 and FIG. 15 illustrate how a discriminator located in a DP service provider 806 may cooperate with a generator located in a DP service customer 802 to execute required DSF tasks, according to an embodiment. FIG. 14 illustrates an architecture for data de-privatization together with a data synthetization function. FIG. 15 illustrates the signal flow when a DP service provider 806 cooperates with an AI-enabled party 1002 to execute DSF 402 tasks. Though similar to other embodiments, in this embodiment, additional interactions and more parameters are needed for the DP service provider 806 and AI-enabled party 1002 to execute the DSF tasks cooperatively. In step 1102, a DP service customer 802 (e.g., DC service provider, NFs, UEs, and 3rd party) sends a DP service request message to a DP service provider 806. The service request from the service customer may comprise information e.g., the requirement on a generative model and/or the preconfigured requirement on a generative model. The DP service request message may include one or more parameters such as a data de-privatization requirement (e.g., data privacy level), a DSF requirement (e.g., DSF ID), a synthetic data requirement (e.g., data synthetic accuracy, synthetic dataset size which indicates the specific or minimum amount of synthetic data needed to be transmitted back), a synthetic data indication, a synthetic method (e.g., GANs, GNN, or VAE), and an address to receive synthetic data. The DA service request message is to indicate that synthetic data needs to be generated for the realistic data 108. The realistic data 108 useful for synthesizing data (e.g., samples of realistic data, samples of labeled data, samples of unlabeled data, and other data such as latent parameters, conditional parameters, denial constraints, and auxiliary parameters, that may need to be used during ML procedure) may be transmitted via the DP service request message or after the DP service request message.

The DP service provider 806 receives the DP service request message and in step 1106 sends a DA service request message to the AI-enabled party 1002 (e.g., DAM DA service provider) to indicate that synthetic data needs to be generated. The service request from the DP service provider may comprise information e.g., the requirement and/or the preconfigured requirement on a generative model. The DA service request message may include one or more parameters e.g., such as data analytics requirements (e.g., analysis delay), DSF requirement (e.g., DSF ID), synthetic data requirements (e.g., specific, or minimum data synthetic accuracy, specific or minimum data synthetic accuracy level, privacy level, specific or minimum data synthetic accuracy, synthetic dataset size), a synthetic data indication, a synthetic method (e.g., GANs, GNN and VAE). Additional parameters of the DA service request message include DSF task (e.g., ML task) split indication, DSF task split details (e.g., generator network only), and specific or thresholds for a number of training epochs. The split indication and/or DSF task split details may be used to indicate how DP service provider 806 and AI enabled party 1002 execute the DSF cooperatively e.g., DP service provider 806 only executes the discriminator network and AI enabled party 1002 only executes the generator network.

After the DA service request message is sent, the DP service provider 806 and the AI-enabled party 1002 compute their respective DSF 402 tasks cooperatively. In step 1502, the AI-enabled party 1002 will execute the generator 104 network, while in step 1504, the DP service provider 806 will execute tasks related to the discriminator 110 network. Necessary information should be exchanged between DP service provider 806 and the AI-enabled party 1002 during the training procedure of the generator 104 and the discriminator 110 in order to train the whole GAN. For example, the DP service provider 806 should inform the AI-enabled party 1002 of the parameter output by the discriminator 110 or other parameters (e.g., latent parameters, conditional parameters, denial constraints, and auxiliary parameters), and the AI-enabled party 1002 should inform the DP service provider 806 of the samples of generated data.

In embodiments, if the DA service provider is trustworthy (e.g., a member of the same DAM consortium as the DP service customer 802 or other association), the DP service provider 806 could execute its DSF tasks with the help of the DA service provider, and the other parts of the DSF tasks can be executed by other AI-enabled parties.

In step 1110, the AI-enabled party 1002 (e.g., a DA service provider) sends a DA service response message to DP service provider 806, the DA service response message may include one or more parameters such as a synthetic data indication, a data model (e.g., generative model) indication, a synthetic data size, a data model (e.g., generative model) size, a data model type ID, a synthetic data accuracy indicator, and a privacy level. The AI-enabled party 1002 may send the synthetic data information or data model (e.g., generative model) information to the DP service provider 806. The data model information may include one or more parameters such as a model parameter, a model hyper-parameter (e.g., variable z distribution), and other parameters (e.g., latent parameter, conditional parameter, denial constraints, and auxiliary parameter), specific and minimum computing and/or time resource requirement to compute the data model, model validity information (e.g., valid time, valid scope such as specific PLMNs, NPNs, slices, TAs, cells, UEs or a valid area, a geographic region or a valid data source type (e.g., mobile terminal, vehicle, UE type 1, UE type 2, vehicle type 1, vehicle type 2)). The synthetic data 106 or the configuration information may be delivered to DP service provider by AI enabled party.

In step 1114, the DP service provider 806 sends a DP service response to the DP service customer 802 (as also illustrated in FIG. 11). The message is to indicate the transmission of the synthetic data 106 or the data model (e.g., generative model) information. The data model information may comprise the configuration information. The message may include one or more parameters e.g., synthetic data information (e.g., synthetic data size, data model size, synthetic data accuracy, privacy level), DSF ID. If the DP service provider 806 receives synthetic data 106 from AI-enabled party 1002, it forwards the synthetic data 106 to the DP service customer 802. If the DP service provider 806 receives data model (e.g., generative model) information, the DP service provider 806 generates the synthetic data 106 with the generator data model and then forwards the synthetic data 106 to the DP service customer 802. Optionally, the DP service provider 806 may forward only the data model to the DP service customer 802. One or more of: the synthetic data 106 and the configuration information may be delivered to DP service customer by DP service provider.

Optionally, in step 1116, the DP service provider may send a data release and provision message to the data consumer 810. The message is to indicate the transmission of the synthetic data 106 or the data model (e.g., generative model) information. The data model information may comprise the configuration information. The DP service provider 806 may directly store the synthetic data 106, the data model (e.g., generative model) information, or both the synthetic data 106 and the data model into the DAM internal storage or forward it to the data consumer 810, such as a 3rd party AI market or data market, for further use. One or more of: the synthetic data 106 and the configuration information may be delivered to the data consumer by DP service provider.

Optionally, in step 1118, the AI enabled party may send a data release and provision message to the data consumer 810. The message is to indicate the transmission of the synthetic data 106 or the data model (e.g., generative model) information. The data model information may comprise the configuration information. The DA service provider may directly store the synthetic data 106, the data model (e.g., generative model) information, or both the synthetic data 106 and the data model into the DAM internal storage or forward it to the Data consumer 810 for further use. One or more of: the synthetic data 106 and the configuration information may be delivered to the data consumer by DP service provider.

In embodiments, the DSF 402 tasks to synthesize data may be split between a DP service provider 806 and an AI-enabled party 1002. The DSF 402 tasks which may require access to the realistic data 108 are executed by the DP service provider 806, while the other tasks are executed by the AI-enabled party 1002. Only the data source 808 and the DP service provider 806 touch the private data. The approach is suitable when the AI-enabled party 1002 is untrusted, especially in the open ecosystem. The approach allows flexible data sharing and reduces data transmission overhead.

FIG. 16 illustrates function splitting among a DP service customer 802 and a DP service provider 806, according to an embodiment where the DP service provider 806 is not trustworthy from the point of view of preserving the privacy of the realistic data 108. The discriminator is located in the service customer and the generator is located in the DP service provider as illustrated in FIG. 26. The DP service provider 806 is prevented from accessing the realistic data 108 which is only accessible to the DP service customer 802 that is the owner or provider of the realistic data 108. The DP service provider 806 has access to the random distribution data and assistant data with which to train the generator 104. A DP service customer 802 has realistic data 108 and performs DSF 402 calculations to train discriminator 110 and determines if samples are real or fake at decision block 112. A DP service provider 806, which is not necessarily trusted by the DP service customer 802, performs calculations required to train generator 104 and to generate synthesized data 106. The DP service provider 806 receives the results from block 112 to aid in training generator 104. In FIG. 16, the dashed line indicates the division of tasks between the DP service customer 802 and the DP service provider 806.

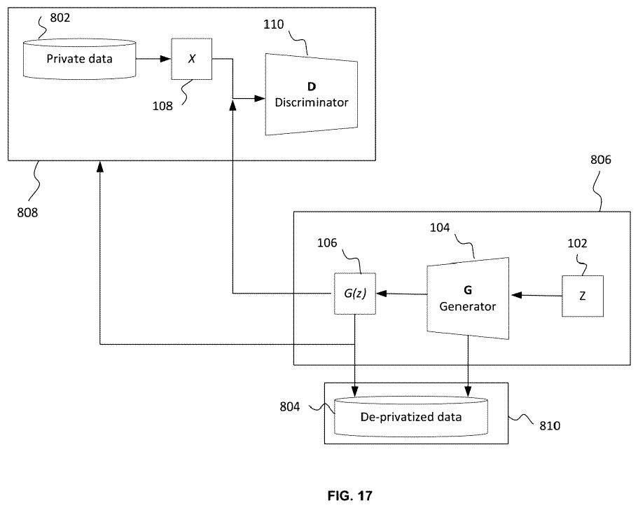

FIG. 17 illustrates an embodiment where a DP service customer 802 executes discriminator 110 components, and a DP service provider 806 executes the generator 104 components. The discriminator is located in the service customer and the generator is located in the DP service provider as illustrated in FIG. 26. The DP service provider 806 may output synthetic data 106, a generative model, or both synthetic data 106 and the generative model to data storage for de-privatized data 804.

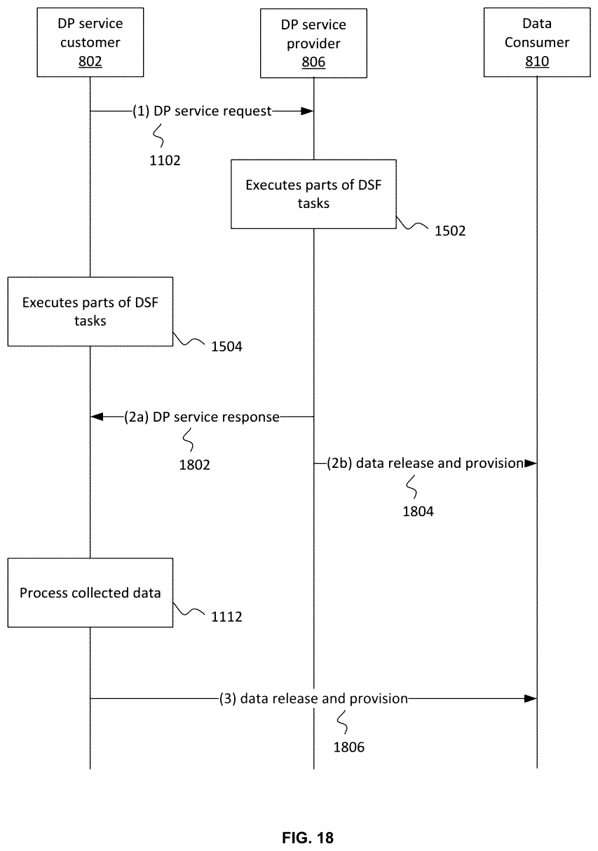

FIG. 18 illustrates a method where a DP service provider 806 cooperates with a DP service customer 802 to execute the DSF 402 tasks, according to an embodiment. The method of FIG. 18 may utilize the embodiment shown in FIG. 16 and the architecture of FIG. 17. In step 1102, a DP service customer 802 (e.g., a DC service provider, NFs, UEs, and 3rd party) sends a DP service request message to a DP service provider 806. The service request from the service customer may comprise information e.g., the requirement and/or the preconfigured requirement on a generative model. The DP service request may include one or more parameter such as a data de-privatization requirement (e.g., data privacy level), a DSF requirement (e.g., DSF ID), a synthetic data requirement (e.g., data synthetic accuracy, synthetic dataset size which indicates the specific or minimum amount of synthetic data needed to be transmitted back), a synthetic data indication, a synthetic method (e.g., GANs, GNN and VAE), or an address to receive synthetic data. Other parameters include a DSF task (e.g., ML task) split indication, DSF task split details (e.g., for the generator 104 network only), or specific thresholds of the number of training epochs to be used. The DP service request message may be used to indicate that synthetic data 106 needs to be generated for the realistic data 108. In embodiments, the private data used for synthesizing synthetic data 108 (e.g., samples of realistic data, samples of labeled data, samples of unlabeled data) is not transmitted to DP service provider 806.

After the DP service request message has been received by the DP service provider 806, the DP service provider 806 and the DP service customer 802 compute their respective DSF 302 tasks cooperatively. Tasks to train the generator network 104 and the discriminator network 110 are executed by the DP service provider 806 and DP service customer 802, respectively. Necessary information should be exchanged between the DP service provider 806 and DP service customer 802 during the training procedure in order to train the whole GAN. For example, the DP service customer 802 should inform the DP service provider 806 of the parameter output by the discriminator and/or other parameters (e.g., latent parameters, conditional parameters, denial constraints, and auxiliary parameters). The DP service provider 806 should inform the DP service customer 802 of the samples of generated sample data.

In response to receiving the DP service request message, in step 1502 the DP service provider executes its DSF 402 task as specified in the DP service request. This may include tasks related to the generator 104 portion of GAN 110 required to obtain synthetic data 106 or the generative model.

After sending the DP service request message, in step 1504 the DP service customer 802 may executes its DSF task. This may include tasks related to the discriminator 110 portion of GAN 100 required to determine between real data 108 and synthetic data 106.

In step 1802, the DP service provider 806 sends a DP service response message to the DP service customer 802. The message is to indicate the transmission of the synthetic data 106 or the data model (e.g., generative model) information. The data model information may comprise the configuration information. The message may include one or more parameter such as synthetic data indication, data model (e.g., generative model) indication, synthetic data size, data model (e.g., generative model) size, data model type ID, synthetic data accuracy, and privacy level. In or after the DP service response message, the DP service provider 806 may deliver the synthetic data 106, the data model or both the synthetic data 106 and the data model (e.g., generative model 104) information to DP service customer for further use.

In step 1804, the DP service provider 806 may send a data release and provision message to a data consumer 810. The message is to indicate the transmission of the synthetic data 106 or the data model (e.g., generative model) information. The data model information may comprise the configuration information. The DP service provider 806 may directly store the synthetic data 106, the data model or both the synthetic data 106 and the data model (e.g., generative model 104) information into the DAM internal storage 804 or forward the data or model to the data consumer 810 for further use. One or more of: the synthetic data 106 and the configuration information may be delivered to the data requester by DP service provider.

In step 1112, the DP service customer 802 processes the data collected by itself, data received in the DP service response message, or both sources of data to perform task such as synthesizing data or labelling data.

In step 1806, the DP service customer 802 may send a data release and provision message to the data consumer 810. The message is to indicate the transmission of the synthetic data 106 or the data model (e.g., generative model) information. The data model information may comprise a configuration information enabling an establishment of the latest updated generative model which generated the latest updated synthetic data. The DP service customer 802 may directly store the synthetic data 106, the data model, or both the synthetic data 106 and the data model (e.g., generative model) information into the DAM internal storage 804 or forward it to the data consumer 810 (e.g., AI market, data market) for further use. One or more of: the synthetic data 106 and the configuration information may be delivered to the data requester by DP service customer.

In the embodiments of FIG. 16, FIG. 17, and FIG. 18, the DSF tasks to synthesize data are split between a DP service customer 802 and a DP service provider 806. The DSF tasks which should access the realistic private data 108 are executed by the DP service customer 802 itself, while the other DSF tasks are executed by the DP service provider 806. Only the data source 808 and the DP service customer 802 may access the private data. These embodiments are suitable when the DP service provider 806 is untrusted by the DP service customer 802 or the data source 808, which may be a concern in an open ecosystem. This approach allows for flexible data sharing and reduces data transmission overhead.

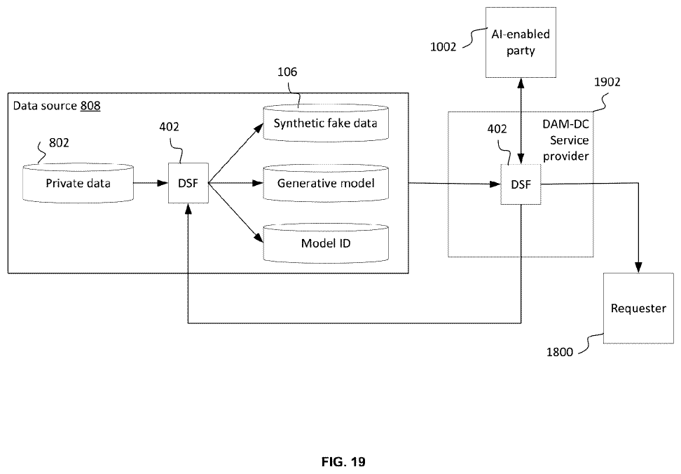

FIG. 19 illustrates an architecture for efficient data collection with a DSF, according to an embodiment where the DSF 402 may be deployed flexibly with a DC service provider, a data source 808, or both a DC service provider and a data source 808, according to an embodiment. A DC service provider 1902 is pre-configured with DSF information (e.g., DSF ID list, DSF validity information, a trained generative model) which may be done via an AI-enabled party 1002, OAM system, or by other means. The DC service provider 1902 may indicate DSF validity information (e.g., DSF ID and its valid time, valid scope such as specific PLMNs, NPNs, slices, TAs, cells, UEs or valid area, a geographic region, or a valid data source type (e.g. mobile terminal, vehicle, UE type 1, UE type 2, vehicle type 1, vehicle type 2)) to data sources 808 via DS-associated signaling or non-associated signaling such as Radio Resource Control (RRC) message, System Information (SI), or User Plane (UP) signaling or data. The DC service provider 1902 may also transmit synthetic data 106 to the data consumer 810. The data source 808 may be pre-configured with DSF information via an AI-enabled party 1002, OAM system etc. The data source 808 checks the validity of the data model. If the data model is valid, the data source 808 may transmit synthetic fake data, generative model or a model ID to the DC service provider 1902. If the data source 808 determines that the data model is not valid, it may send an invalid indication and synthetic data, or an updated data model. In embodiments, the data source 808 may execute all DSF 402 tasks or parts of DSF tasks. For example, discriminator 110 training may be executed by the data source 808, while training of the generator may be executed in the DC service provider. In embodiments, the model ID may indicate detailed parameters of a generative model or a data model. These parameters may include information such as model type, model architecture, hyper-parameter, number of layers, nodes in each layer, or weights between different nodes. Other parameters include a model ID indicating the detailed parameters of the generative model or data model, a model size indicating the data volume of the generative model or data model, an accuracy level indicating an achievable specific or minimum performance accuracy by using the synthetic data, generative model or data model in place of the private data, a privacy level indicating an achievable specific or minimum degree to protect the privacy of the private data by using the synthetic data, generative model or data model in place of the private data, a specific or minimum computing or time resource requirement to compute the generative model or the data model, or model validity information.

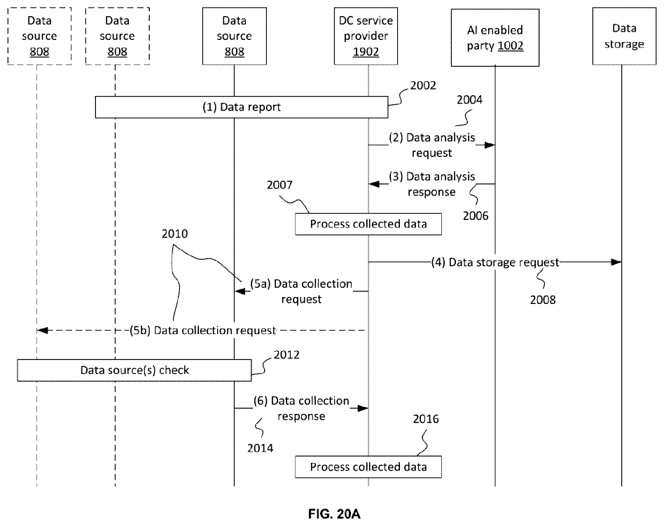

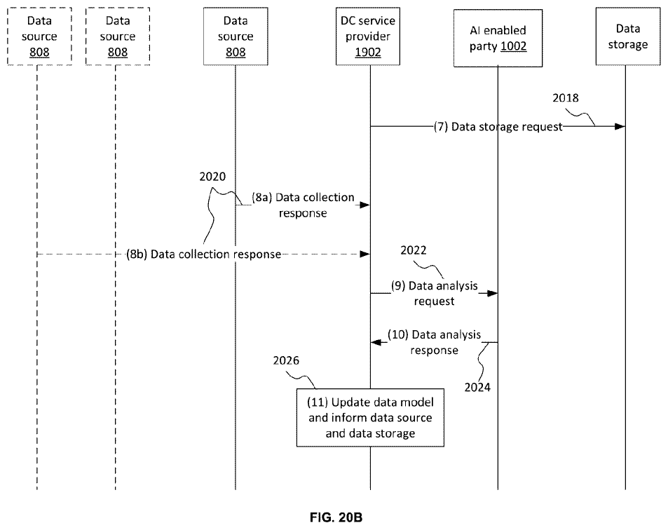

FIG. 20A and FIG. 20B illustrate a method for data collection with a DSF 402 using the architecture of FIG. 19, according to an embodiment. A requester e.g., a data storage, may send a request message to a DC service provider for a service of a collection of data. In step 2002, a data report is provided to the DC service provider 1902 by one or more data sources 808. The reported data can be labeled data, unlabeled data, or a mix of labeled and unlabeled data, and the data source 808 type may be indicated in the data report. The reported data can be regarded as public data with less privacy requirements so that it can be directly used for data model training. In step 2004, the DC service provider 1902 sends a data analysis request message to an AI-enabled party 1002 (e.g., DAM DA service provider), the data analysis request message may include one or more parameters such as data analytics requirements (e.g., analysis delay), DSF requirements (e.g., DSF ID), data model requirements (e.g., data model accuracy level, privacy level, data compression ratio, accuracy level of the synthetic data generated by the data model, privacy level of the synthetic data generated by the data model, and data compression ratio to compress the private dataset to the synthetic dataset), and data analytics methods (e.g., GANs, GNN and VAE). The data analysis message may be used to indicate that a data model needs to be trained for the realistic data 108. The AI enabled party may determine the generative model and then send and configure the determined generative model to DC service provider and data source(s). The AI-enabled party may be an entity capable of providing DP service, e.g., the DP service provider. And the DC service provider and data source(s) are the data consumer 810. Data useful for training data models (e.g., samples of realistic data, samples of labeled data, samples of unlabeled data, and other data such as latent parameters, conditional parameters, denial constraints, and auxiliary parameters that may be used during the ML procedure, may be transmitted via the data analysis request message or after the data analysis request message.

In embodiments, for a data collection service, the functions of data models (e.g., generative model, discriminative model, encoder model, decoder model, information compression model, semantic information model on network) may be used to reduce the overhead of data collection and transmission. Based on the data model, the original realistic data 108 can be compressed or synthetic data can be generated, and the necessary information (e.g., semantic features for semantic communication) of the realistic data 108 can be inferred and reconstructed from the compressed data or the synthetic data 106. The functions of the data model may also be used for automatic data processing such as data feature engineering, data labeling, or data classification.

In embodiments, the data model can be trained using privacy-preserving methods including differential privacy, homomorphic encryption, secure multi-party computation, trusted execution environment, and secure enclaves.

In embodiments, the DC service provider 1902 can execute a complete set of DSF 402 tasks itself, or with the help of an AI-enabled party 1002 which executes the complete set of DSF 402 tasks, or cooperatively with an AI-enabled party 1002 where each party executes its portion of the DSF tasks.

In step 2006, the AI-enabled party 1002 (e.g., a DA service provider) sends a data analysis response message to the DC service provider 1902. Before sending the data analysis response message, the AI-enabled party 1002 may execute DSF tasks, such as GAN 100 training tasks, based on the requirements of the DC service provider 1902, to obtain the data model information. Data model information may be sent to the DC service provider 1902 via the data analysis response, or after the data analysis response. The data model information may include one or more parameter such as data model type ID, DSF ID, model parameter, model hyper-parameter (e.g., variable z distribution), and other parameters such as latent parameters, conditional parameters, denial constraints, and auxiliary parameters, specific and minimum computing and/or time resource requirement to compute the generative model, model validity information (e.g., valid time, valid scope such as specific PLMNs, NPNs, slices, TAs, cells, UEs or valid area, a geographic region, or a valid data source type (e.g., mobile terminal, vehicle, UE type 1, UE type 2, vehicle type 1, vehicle type 2)), data model size, data model accuracy level, data model privacy level, and data compression ratio. The configuration information enabling an establishment of the generative model which generates the synthetic data may be delivered to DC service provider by AI enabled party.

In embodiments, the valid scope may include one or more of the following information. A public land mobile network (PLMN) that may indicate that the generative model, synthetic data, or data model is valid in the specific PLMN. A Non-Public Network (NPN) that may indicate that the generative model, synthetic data, or data model is valid in a specific NPN. A network slice that may indicate that the generative model, synthetic data, or data model is valid for a specific network slice. A Tracking Area (TA) that may indicate that the generative model, synthetic data, or data model is valid in a specific TA. A network cell that may indicate that the generative model, synthetic data, or data model is valid in a specific network cell. A user equipment (UE) that may indicate that the generative model, synthetic data, or data model is valid for a specific UE. A data source type that may indicate that the generative model, synthetic data, or data model is valid for a specific type of data source. A radio access network (RAN) node that may indicate that the generative model, synthetic data, or data model is valid for a specific RAN node. A network function (NF) that may indicate that the generative model, synthetic data, or data model is valid for the specific NF. A valid area that may indicate that the generative model, synthetic data, or data model is valid in a specific area.

The data model type may be pre-configured in the DC service provider 1902 by the AI-enabled party 1002 or other parties such as an OAM. Sending the model type rather than detailed model parameters can reduce the overhead between the DC service provider 1902 and the AI-enabled party 1002. The data model type can indicate the data model information e.g., model parameters such as model architecture, algorithm (e.g., GNN, GAN, VAE, DNN, RNN), number of layers, nodes in each layer, and even more detailed information such as specific weights between different nodes.

In step 2008, the DC service provider 1902 sends the synthetic data 106, the data model information, or both the synthetic data and the data model information to DAM internal storage or a 3rd party (e.g., AI market, data market) for further use. Before sending the synthetic data 106 or data model information, in step 2007 the DC service provider 1902 may process the collected data based on the data model. Processing in step 2007 may include data synthesizing or feature engineering. The quality-of-data (QoD) or quality-of-data-model (QoDM) such as data completeness, validity, privacy, or accuracy, may be indicated when the data or data model information is sent.

In step 2010, the DC service provider 1902 may send a data collection request message to any or all of data sources 808. The data sources in step 2010 are not limited to the data sources reporting data in step 2002. The data collection message may include one or more parameters such as data collection requirement, data model information (e.g., DSF ID, data mode type ID, model valid information). The data collection message may use data source-associated signaling (RRC message, UP signaling) or non-data-source-associated signaling (e.g., system information (SI), paging). The data model type may be pre-configured to a data source 808 by the DC service provider 1902 or other parties including AI-enabled party, OAM system. Sending the data model type rather than detailed model parameters can reduce the overhead between DC service provider 1902 and the data source 808.

Based on the received data model, the data source 808 may compress the realistic data and/or synthesized data. Based on the received data model, the data source 808 may automatically process data including any of feature engineering, data labeling, or data classification.

In step 2012, the data sources 808 that received the data collection request message(s) check whether the data model is valid, for example, based on whether the data to be reported is (performance) consistent with the synthetic data generated by data model, or whether data model valid information is suitable or out of date. For example, the synthetic data and the data to be reported are considered to be not consistent if the difference between them is higher than a threshold value, or the coherence between them is lower than a threshold value. For example, a trained discriminative model may be preconfigured together with the data model to data source. The synthetic data and the data to be reported are considered to be consistent if the discriminative model cannot distinguish them.

If the data model is valid, then in step 2014, the data source 808 sends a data collection response message to the DC service provider 1902. The data collection response message may include one or more parameters such as data model type ID, model valid indication, and assistant data (e.g., inference data) which can be used to generate the realistic data 108 or synthetic data 106 together with the data model. Additionally, the data source 808 may select to not send a data collection response message 2014 in cases where the DC service provider 1902 already knows the data model and the realistic data 108 can be inferred. This implies that the data model is still valid without the data collection response message. Optionally, the data source 808 may transmit compressed data of the realistic data 108, or synthetic data 106 to the DC service provider 1902. Optionally, the data source(s) 808 may automatically process data, such as performing feature engineering, data labeling or data classification based on the valid data model. The automatically processed data features, labels and classes could be indicated by the data source(s) 808 to the DC service provider 1902.

In step 2018, the DC service provider 1902 may send one or more of: the synthetic data 106 and the configuration information may be delivered to a data requester e.g., DAM internal storage or a 3rd party (e.g., AI market, data market) for further use. The data model information may comprise the configuration information enabling an establishment of the latest updated generative model which generates the latest updated synthetic data.

Before sending the synthetic data 106 or the data model information, in step 2016 the DC service provider 1902 may process (e.g., data synthesizing, and feature engineering) the collected data based on the stored data model.

In step 2012, if when the data source 808 checks whether the data model is valid, and determines that any data model is invalid, the data source(s) 808 may send a data collection response message 2020 to the DC service provider. The data collection response(s) may include one or more parameters such as data model type ID, a model invalid indication, a model update indication, or model update requirements. Realistic data may be sent from data sources 808 to the DC service provider 1902 via the data collection response message or after the data collection response message. In embodiments, the compressed data (e.g., semantic information) of the realistic data could be delivered, and the related information to decompress the data may be indicated at the same time.

In step 2022, the DC service provider 1902 may send a data analysis request message to the AI-enabled party 1002 (e.g., DAM DA service provider). The data analysis request message may include one or more parameters such as a data analytics requirement (e.g., analysis delay), a DSF requirement (e.g., DSF ID), a data model requirement (e.g., data model accuracy level, privacy level, data compression ratio), a data analytics method (e.g., GANs, GNN, or VAE). The data analysis message may be used to indicate that the data model needs to be updated. The data useful to update the data model (e.g., data model reported by data source 808, samples of realistic data, samples of labeled data, samples of unlabeled data, and other data (e.g., latent parameter, conditional parameter, denial constraints, and auxiliary parameter) need to be used during ML procedure) may be transmitted via the data analysis request message or after the data analysis request message.

In embodiments, the data analysis request may include one or more parameters including one of a data synthetization function (DSF) requirementID, a data synthetization indication, a data synthetization accuracy level, a data synthetization privacy level, a dataset size, a data model requirement, or a data analytics method. A data synthetization function (DSF) requirement ID may indicate the detailed data analysis service requirement for data synthetization. A data synthetization indication may indicate that a data synthetization service is needed. A data synthetization accuracy level may indicate an achievable specific or minimum performance accuracy by using the synthetic data, generative model or data model in place of the private data. A data synthetization privacy level may indicate an achievable specific or minimum degree to protect the privacy of the private data by using the synthetic data, generative model or data model in place of the private data. A dataset size may indicate the specific or minimum amount of synthetic data to be generated. A data model requirement may indicate a specific requirement of the data model to be trained. The data model requirement may include one or more of an accuracy level of the synthetic data generated by the data model, a privacy level of the synthetic data generated by the data model, and a data compression ratio to compress the private dataset to the synthetic dataset. A data analytics method may indicate a specific method to perform data synthetization.

In step 2024, the AI-enabled party 1002 (e.g., DA service provider) may send a DA analysis response message to the DC service provider 1902. An updated data model, an updated data model information, or both an updated data model, updated data model information may be sent with the data analysis response message or after the data analysis response message.

In step 2026, after receiving the updated data model information, the DC service provider 1902 informs the data source 808 as in step 2010 and informs the data requester e.g., the data storage as in step 2008.

In embodiments, the data source 808 may be UE and the DC service provider may be RAN or CN NFs.

In embodiments, the data model information for data collection can be indicated via data source-associated signaling (RRC message, UP signaling) or non-data-source-associated signaling (e.g., system information (SI), paging). When the data model is suitable, the synthetic data 106, or the compressed data or the data model type ID or even no information instead of the realistic data 108 needs to be transmitted to a data service provider. These embodiments not only reduce the data collection overhead, but also de-privatize the data. In this approach, there may be no party in the ecosystem other than it is the data source 808 that has access to the realistic data.

In embodiments, as in FIG. 19, FIG. 20A and FIG. 20B, the data collection service provider and the data source can be the data consumer of DP service provider or an AI-enabled party. After the DP service provider or an AI-enabled party, determines the latest updated generative model. The DP service provider or an AI-enabled party sends the configuration information enabling an establishment of the latest updated generative model which can be used to generate synthetic data to at least one of: data collection entity e.g., data collection service provider which collects data or data source which reports data to be collected.

For example, DP service provider sends the configuration information enabling an establishment of the latest updated generative model which generated the latest updated synthetic data to both the data collection service provider and the data source. The generative model can be established by the data collection service provider and the data source according to the configuration information. The data collection service provider sends a data collection request to the data source. The data collection request can be sent to one or more data sources e.g. via Resource Control (RRC) message, System Information (SI), User Plane (UP) signaling, core network message, inter-RAN node message e.g., message on Xn or X2 interface, intra-RAN node message e.g., message on F1 interface between RAN central unit and RAN distributed unit or E1 interface between control plan of RAN central unit and user plane of RAN central unit, the message between core network and RAN node, the message between core network and UE, or a paging message The data collection request may include one or more model IDs each corresponding to one generative model. The model ID is used to inform the data source that the data collection service provider has locally configured the corresponding generative model related to the model ID, so that the data collection service provider and the data source can align the configured generative model with each other. The data collection service provider sends a data collection request including a requirement. The requirement may include data collection information indicating one of: data type to be collected, when or where the data is to be collected, data quality to be collected. The data quality can be indicated with one or more of a data accuracy level or a privacy level. For example, if the data source wants to report the synthetic data generated by the configured generative model instead of the original data, the synthetic data should meet an accuracy level not lower than a threshold compared with the original data. If the data source wants to report the synthetic data generated by the configured generative model instead of the original data, the synthetic data should meet a privacy level not lower than a threshold to protect the privacy of the original data. The data collection information includes one or more of: time information indicating at which time the data is to be collected, a time period indicating during which time period the data is to be collected, time information indicating that the data produced at the corresponding time is to be collected, a time period indicating that the data produced at the corresponding time period, is to be collected, location information indicating within which area the data is to be collected, location information indicating that the data produced within the corresponding area, is to be collected; and a requirement on one of a data source and an operation platform. The area indicated by the location information includes one of: a public land mobile network (PLMN); a non-public network (NPN); an area related to a network slice; a tracking area (TA) of a terminal; and a network cell. The requirement includes one of parameters of following data source of the data to be collected or operation platform of the data to be collected: a user equipment (UE); a data source type; a radio access network (RAN) node; and a network function (NF). When the data source verified that the configuration information e.g., the validity information is suitable and the synthetic data generated by the generative model is consistent with the original data to be reported to the DC collection service provider. The data source reports at least one of the generative model ID, generative model or the synthetic data to data collection service provider. It reduces the transmission overhead to report the original data and protects the data privacy. As another example, DP service provider sends the configuration information enabling an establishment of the latest updated generative model which can be used to generate synthetic data to the data source but not to the data collection service provider. The generative model can be established by the data source according to the configuration information. The data collection service provider sends a data collection request including the requirement. When the data source verified that the configuration information e.g., the validity information is suitable and the synthetic data generated by the generative model is consistent with the original data to be reported to the DC collection service provider. The data source reports at least one of the configuration information, generative model or the synthetic data to data collection service provider. It reduces the transmission overhead to report the original data and protects the data privacy. As another example, DP service provider sends a data collection request including the configuration information enabling an establishment of the latest updated generative model which can be used to generate synthetic data to the data collection service provider but not to the data source. The generative model can be established by the data collection service provider according to the configuration information. The configuration information may include one or more model IDs each corresponding to one generative model. The data collection service provider sends a data collection request including the requirement. The data collection service provider sends the configuration information to data source. When the data source verified that the configuration information e.g., the validity information is suitable and the synthetic data generated by the generative model is consistent with the original data to be reported to the DC collection service provider. The data source reports at least one of the generative model ID, generative model or the synthetic data to data collection service provider. It reduces the transmission overhead to report the original data and protects the data privacy. When the data collection service provider receives at least one of the generative model ID, generative model or the synthetic data from data source, the data collection service provider sends the data requester e.g. some other data consumer, at least one of the generative model ID, configuration information enabling an establishment of the generative model, and synthetic data which is generated by the first generative model invoked by the data collection service provider locally.

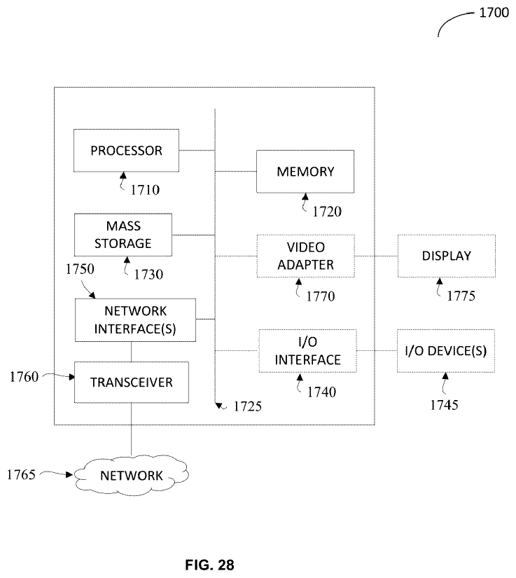

FIG. 28 is a schematic diagram of an electronic device 1700 that may perform any or all of operations of the above methods and features explicitly or implicitly described herein, according to different embodiments of the present invention. For example, a computer equipped with network function may be configured as electronic device 1700.

As shown, the device includes a processor 1710, such as a central processing unit (CPU) or specialized processors such as a graphics processing unit (GPU) or other such processor unit, memory 1720, non-transitory mass storage 1730, I/O interface 1740, network interface 1750, video adaptor 1770, and a transceiver 1760, all of which are communicatively coupled via bi-directional bus 1725. Video adapter 1770 may be connected to one or more of display 1775 and I/O interface 1740 may be connected to one or more of I/O device 1745 which may be used to implement a user interface. According to certain embodiments, any or all of the depicted elements may be utilized, or only a subset of the elements. Further, the device 1700 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 1720 may include any type of non-transitory memory such as static random access memory (SRAM), dynamic random access memory (DRAM), synchronous DRAM (SDRAM), read-only memory (ROM), any combination of such, or the like. The mass storage element 1730 may include any type of non-transitory storage device, such as a solid state drive, hard disk drive, a magnetic disk drive, an optical disk drive, USB drive, or any computer program product configured to store data and machine executable program code. According to certain embodiments, the memory 1720 or mass storage 1730 may have recorded thereon statements and instructions executable by the processor 1710 for performing any of the aforementioned method operations described above.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations, or equivalents that fall within the scope of the present invention.

1. A method of privacy protection comprising:
receiving, by a generator from a service customer, a service request requesting for a service of privacy protection;
determining, by the generator, a generative model to generate synthetic data based on the service request;
performing, by the generative model, a generation of synthetic data, and providing the synthetic data to a discriminator;
performing, by a discriminative model invoked by the discriminator, a comparison between data from the service customer and received synthetic data, and providing a result of the comparison to the generator, wherein privacy of the service customer is included in or inferred from the data from the service customer;
according to the result of the comparison from the discriminator, updating, by the generator, the generative model until updated synthetic data generated by updated generative model meets a preconfigured requirement, and each time when the generative model is updated, providing newly updated synthetic data to the discriminator;
once the preconfigured requirement is met, providing, by the generator to a data consumer, at least one of:
the latest updated synthetic data which meets the preconfigured requirement, and
configuration information enabling an establishment of the latest updated generative model which generated the latest updated synthetic data,
wherein the data consumer has no authorization to access the privacy of the service customer.

2. The method according to claim 1, wherein the service request from the service customer comprises a requirement of a generative model and the generative model determined by the generator meets the requirement of the generative model, wherein the requirement of the generative model includes one or more of:
a model ID identifying the generative model;
a model size of the generative model;
an accuracy level to be supported by the generative model;
a privacy level to be supported by the generative model;
a computing or time resource requirement to establish the generative model;
validity information indicating one or more of:
valid data type to be supported by the generative model, and when or where one of the generative model and data as input to the generative model is valid;
a data compression ratio to be supported by the generative model;
a model type to be supported by the generative model;
hyper-parameters associated with the generative model; and
weights between neurons of a neural network associated with the generative model.

3. The method according to claim 2, wherein the model type includes one of:
a model based on a generative adversarial network (GAN),
a model based on a generative neural network (GNN),
a model based on an auto-encoder, and
a model based on a variational auto-encoder (VAE).

4. The method according to claim 1, wherein the generator has no authorization to access the privacy from the service customer, and the performing, by the generative model, a generation of synthetic data comprises:
generating, by the generative model, synthetic data according to random data and the service request.

5. The method according to claim 1, wherein the updating the generative model comprises:
updating at least one weight between neurons of neural network associated with the generative model or at least one hyper-parameter associated with the generative model.

6. The method according to claim 1, wherein the generator is located in a first entity which has no interface supporting a transmission of the service request from the service customer, the discriminator is located in a second entity which has an interface supporting a transmission of the service request from the service customer, wherein the generator receives the service request from the service customer via the discriminator.

7. The method according to claim 6, further comprising:
receiving, by the discriminator from the service customer, a set of parameters to determine the discriminative model; and
determining, by the discriminator, the discriminative model according to the set of parameters.

8. The method according to claim 6, wherein the second entity is a data de-privatization (DP) service provider, the method further comprises:
receiving, by the generator from the data DP service provider, a split indication indicating that a generative model is required to output data for a comparison performed by a discriminative model;
wherein the generator determines the generative model according to the split indication.

9. The method according to claim 1, wherein the generator is located in a first entity which has an interface supporting a transmission of the service request from the service customer, the discriminator is located in the service customer, wherein the service request includes a split indication indicating that a generative model is required to output data for a comparison performed by a discriminative model.

10. The method according to claim 9, further comprising:
determining, by the service customer, the discriminative model according to a local stored set of parameters.

11. The method according to claim 1, wherein the generator and the discriminator are located in an entity, wherein the service request is received by the entity from the service customer.

12. The method according to claim 11, wherein the entity is a data de-privatization (DP) service provider whose interface with the service customer supports a transmission of one or more of the service request and the data; or, wherein the entity has an interface with a DP service provider and no interface with the service customer, while the DP service provider has an interface supporting a transmission of one or more of the service request and the data with the service customer, and the service request is received by the entity from the service customer via the DP service provider.

13. The method according to claim 12, wherein the DP service provider is configured to determine how to generate the generative model and the discriminator model according to the service request.

14. The method according to claim 1, further comprising one of:
receiving, by the discriminator, the data from the service customer via an interface between the discriminator and the service customer; and
obtaining, by the discriminator, the data locally in the service customer wherein the discriminator is located in the service customer.

15. The method according to claim 1, further comprising:
for each time when the synthetic data is generated, determining, by the generator, whether the preconfigured requirement is met, the preconfigured requirement indicating at least one of:
how many times the synthetic data can be generated at most,
how many times the generative model can be updated at most,
how much similarity is between latest two generative models at least, and
an indication is received from the discriminator wherein the indication indicates to provide the latest updated synthetic data or the configuration information enabling the establishment of the latest updated generative model to the data consumer.

16. The method according to claim 15, further comprising:
sending, by the discriminator to the generator, a message including the preconfigured requirement to configure the preconfigured requirement into the generator, wherein the discriminator and the generator are located in different entities.

17. The method according to claim 16, wherein the discriminator is located in the service customer and the message including the preconfigured requirement is the service request from the service customer.

18. The method according to claim 1, further comprising:
for each time when the comparison is performed, determining, by the discriminator, whether the preconfigured requirement is met, wherein the preconfigured requirement indicating at least one of:
how many comparisons can be performed at most; and
how many times the discriminative model can be updated at most.

19. The method according to claim 18, wherein the preconfigured requirement is preconfigured into the discriminator by the service customer.

20. A system including a generator and a discriminator, wherein the generator is configured to perform the steps of:
receiving from a service customer, a service request requesting for a service of privacy protection;
determining a generative model to generate synthetic data based on the service request;
providing the synthetic data to a discriminator;
receiving a result of a comparison between data from the service customer and received synthetic data from the discriminator;
according to the result of the comparison, updating the generative model until updated synthetic data generated by updated generative model meets a preconfigured requirement, and each time when the generative model is updated, providing newly updated synthetic data to the discriminator;
once the preconfigured requirement is met, providing, by the generator to a data consumer, at least one of:
the latest updated synthetic data which meets the preconfigured requirement, and
configuration information enabling an establishment of the latest updated generative model which generated the latest updated synthetic data,
wherein the data consumer has no authorization to access the privacy of the service customer;
the discriminator is configured to perform the steps of:
invoking a discriminative model to perform the comparison between data from the service customer and received synthetic data, and providing a result of the comparison to the generator, wherein privacy of the service customer is included in or inferred from the data from the service customer.
